(19) United States
(12) Patent Application Publication
(10) Pub. No.: US 2021/0255744 A1
(43) Pub. Date: Aug. 19, 2021

(54) Methods, Apparatuses And Computer Program Product For Updating Group-Based Communication Interface

(71) Applicant: Slack Technologies, Inc., San Francisco, CA (US)

(72) Inventors: Christopher Sullivan, Wellesley, MA (US); Myles Grant, San Carlos, CA (US); Michael Demmer, San Francisco, CA (US); Shanan Delp, San Francisco, CA (US); Sri Vasamsetti, San Francisco, CA (US)

(21) Appl. No.: 17/160,158

(22) Filed: Jan. 27, 2021

Related U.S. Application Data
(60) Provisional application No. 62/977,645, filed on Feb. 17, 2020.

(51) Int. Cl. G06F 3/0482; H04L 12/58; H04L 29/08

(52) U.S. Cl. CPC G06F 3/0482; H04L 67/306; H04L 67/36; H04L 51/32

(57) ABSTRACT

Techniques for updating a user interface associated with a communication platform are described herein. The communication platform can enable communications between two or more organizations, such as via a shared resource. The shared resource can include a communication channel, workspace, direct messaging instance, board, or other resource associated with messaging communications. In some examples, the communication platform can receive a request to view a shared resource and can identify two or more organizations associated with the shared resource. Based on the identified two or more organizations, the communication platform can cause a user interface to be presented on a computing device associated with the request. The user interface can include indicators and/or data associated with the two or more organizations, such as to provide an indication that messages transmitted via the shared resource will be shared with members of different organizations.

### PRIORITY

This application claims priority to U.S. Provisional Application No. 62/977,645, filed on Feb. 17, 2020, the entire contents of which are incorporated by reference herein.

### BACKGROUND

Applicant has identified technical deficiencies and problems associated with communication systems and network devices. For example, many methods, apparatus, and systems fail to overcome technical challenges associated with establishing a computing system architecture and generating user interfaces that would allow users from multiple, different organizations to communicate with one another through a messaging platform.

### BRIEF DESCRIPTION OF THE DRAWINGS

Various examples of the present disclosure are described more fully hereinafter with reference to the accompanying drawings, in which some, but not all examples of the disclosure are shown. The drawings are not drawn to scale and like numbers refer to like elements throughout.

FIG. 1 is an example environment for performing techniques described in the present disclosure.

FIG. 2 is an example datastore associated with the example environment described with regard to FIG. 1.

FIG. 3 is an example user interface associated with a communication platform, as described in the present disclosure.

FIG. 4 is an example flowchart illustrating an example method in accordance with some examples of the present disclosure.

FIGS. 5-21 are example illustrations showing example elements associated with example group-based communication interfaces in accordance with some examples of the present disclosure.

FIG. 22 is an example flowchart illustrating an example method in accordance with some examples of the present disclosure.

FIGS. 23-27 are example illustrations showing example elements associated with example group-based communication interfaces in accordance with some examples of the present disclosure.

FIG. 28 is an example flowchart illustrating an example method in accordance with some examples of the present disclosure.

FIGS. 29-42 are illustrations showing example elements of example group-based communication interfaces in accordance with some examples of the present disclosure.

FIG. 43 is an example flowchart illustrating an example method in accordance with some examples of the present disclosure.

FIGS. 44-55 are example illustrations showing example elements of example group-based communication interfaces in accordance with some examples of the present disclosure.

### DETAILED DESCRIPTION OF VARIOUS EXAMPLES

Managing communication interfaces to enable users from two or more organizations to communicate via a communication platform is described. In at least one example, the communication platform can be a channel-based communication system, a permission-based communication system, a channel-based messaging system, and/or any other system for facilitating communication between and among groups of users. Users of the communication platform can collaborate and/or communicate via resources of the communication platform. Resources can include channels, direct messages, workspaces (e.g., collection of channels), boards, and/or the like, each of which are described in more detail below. In some examples, access to such resources can be “group-based,” such that resources have security (that can be defined by permissions) to limit access to defined groups of users. In some examples, groups of users can be defined by identifiers (e.g., group identifiers), which can be associated with common access credentials, domains, or the like. Resources that are shared between two or more groups can be referred to as “shared resources.” That is, for the purpose of this discussion, a shared resource can comprise any resource, as described herein, that is shared between two or more groups. A shared resource, therefore, can comprise a channel shared between two or more groups, a direct message between users of two or more groups, a workspace shared between two or more groups, a board shared between two or more groups, and/or the like. Techniques described herein relate to generating and providing user interfaces (e.g., group-based communication interfaces) associated with shared resources of the communication platform.

In at least one example, the user interfaces may be associated with shared channels. A channel can comprise a virtual communications environment or feed that is configured to display messages posted by channel members (e.g., validated users accessing the environment using user computing devices) that are viewable only to the members of the channel. As discussed above, a shared channel may include members of different organizations. For example, when a user, Brandon, from ACME Corporation intends to collaborate or share data (for example, exchanging messaging communications) with another user, Lisa, from Beta Brands and another user, Thomas, from Global Logistics, Brandon may create a shared channel (e.g., #wholesale-strategy) structured in accordance with various embodiments for this purpose. Once membership for Lisa and Thomas has been validated through an administrative authorization and confirmation process, Brandon, Lisa, and Thomas may freely communicate and collaborate via the #wholesale-strategy shared channel. Multiple additional member users from ACME Corporation, Beta Brands, Global Logistics, and/or any other organizations may be added through similar administrative authorization and confirmation processes.

In an example, a user interface associated with the channel, or format of the channel, can appear differently to different members of the channel; however, in some examples, the content of the channel (i.e., messages) can be displayed to each member of the channel based on common message data. In some examples, the message data can include data that describes the message and that can be used to index, render, query, or organize messages within the communication platform. The message data can include metadata, such as, but not limited to a sending user identifier, a message identifier, a group identifier, a channel identifier, a timestamp, one or more graphical objects that are added or appended to a message (e.g., as emojis or reaction), or the like.

In various examples, the user interface and/or features associated therewith displayed to a particular user may be determined based on an organizational association with the particular user and/or a different organizational association with another user, such as a sender of a message via a shared channel. For example, the communication platform can be configured to cause a display of an organizational identification for users interacting with the shared channel, such as to maintain privacy protocols for information posted thereto. In such an example, a parameter for certain privacy protocols can include organizational identification of users associated with the shared channel.

In some examples, the communication platform can be configured to utilize the organizational identification of users (e.g., a group identifier associated with an organization to which a user belongs) to apply data retention settings to messaging communications posted via a shared communication channel. Administrators of organizations associated with a shared communication channel can establish data retention settings (e.g., data retention policy) for respective organizations. In some examples, the data retention settings can be specific to a shared communication channel and/or can apply to any shared and/or non-shared (e.g., internal) channels. That is, administrators can determine a time period for retaining messages sent or otherwise posted by members of their organization. For example, a first administrative user from ACME Corporation can establish data retention settings that apply to messaging communications posted by Brandon to the #wholesale-strategy channel while a second administrative user from Beta Brands can establish different data retention settings that apply to messaging communications posted by Lisa and so on. In response to the input from the first administrative user, the communication platform can retain (e.g., store) messages sent by Brandon for a first period of time and in response to the input from the second administrative user, the communication platform can retain messages sent by Lisa for a second period of time. The communication platform can be configured to update a user interface associated with the shared channel to remove messages that are deleted based on the data retention settings.

Additionally or alternatively, the communication platform can be configured to update a user interface to include prominent graphical indicators (e.g., shared communication organization set interface, shared channel organization context interface) providing an indication that particular users of a shared channel are associated with other organizations. For example, when any of users Brandon, Lisa, or Thomas access the #wholesale-strategy shared channel, the user interface that is displayed to each of their respective client devices may include an organization header that displays logo icons for each of ACME Corporation, Beta Brands, and Global Logistics.

In some examples, a more dynamic and contextual reminder of the external-nature of shared channels is provided. For example, when a user such as Lisa engages a messaging input interface associated with the #wholesale-strategy externally shared channel, a pop-up notification (e.g., a shared channel organization context interface) may be triggered for display proximate the messaging input interface that contains an organization header so that Lisa is reminded that any posted messaging communications will be shared to ACME Corporation and Global Logistics (i.e., not simply limited to her own organization).

Though described herein primarily in the context of shared channels, the techniques described herein are applicable to any sharable and/or shared resource associated with the communication platform. As described herein, such techniques can be applicable to channels, direct messages, workspaces, boards, and/or the like. As such, techniques described herein relate to the generating and providing user interfaces configured to enable associated users of sharable and/or shared resources of the communication platform to communicate with one another.

Systems structured in accordance with various examples of the invention provide specific, technical solutions to technical problems faced by existing systems, the details of which are described hereinafter.

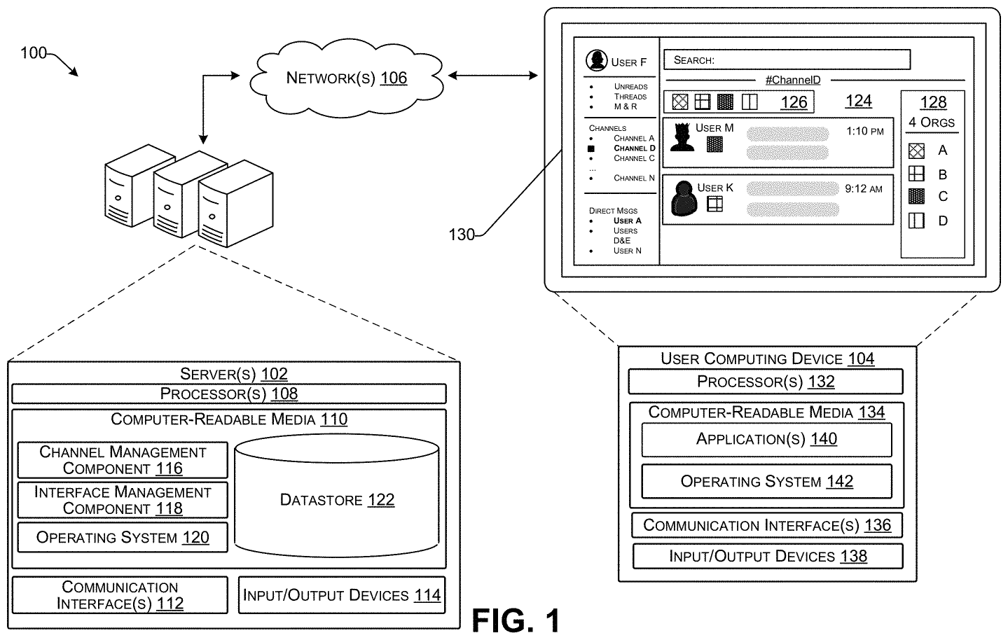

FIG. 1 illustrates an example environment 100 for performing techniques described herein, which relate to generating and providing interfaces associated with shared resources. In at least one example, the example environment 100 can include one or more server computing devices (or “server(s)”) 102. In at least one example, the server(s) 102 can include one or more computing devices that can be embodied in any number of ways. For example, in the case of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can be associated with a communication platform that can leverage a network-based computing system to enable users of the communication platform to exchange messages and/or other data. In some examples, the communication platform can be a hub, offering a secure and private virtual space to enable users to chat, meet, call, collaborate, transfer files or other data, message, or otherwise communicate between or among each other. In at least one example, the communication platform can be “group-based”such that the platform, and associated systems, channels, messages, and/or virtual spaces, have security (that can be defined by permissions) to limit access to defined groups of users. Access can be facilitated by a validated request to join or an invitation to join transmitted by one group member user to another non-member user.

In some examples, groups of users can be defined by identifiers (e.g., group identifiers), which can be associated with common access credentials, domains, or the like. In at least one example, group identifiers can be used to associate data, information, messages, users, channels, etc., with specific groups of a communication platform as defined below. Each group identifier can be one or more items of data by which a group within the communication platform can be identified. For example, a group identifier can comprise ASCII text, a pointer, a memory address, and the like. In one example, a group identifier can be stored as a 64-bit unsigned integer and represented externally (outside of memory) as a base-34 encoded string. In another example, the group identifier can comprise a combination of ASCII characters. Group identifiers can be used to distinguish user access to channels, messages, files, members, etc.

In some examples, each group can be associated with an organization, which can be associated with an organization identifier. Users associated with the organization identifier can chat, meet, call, collaborate, transfer files or other data, message, or otherwise communicate between or among each other in a secure and private virtual space available via the communication platform. An organization identifier, as used herein, can refer to one or more items of data by which an organization within the communication platform can be uniquely identified. In embodiments, differing organizations as referenced herein refer to different enterprises, companies, or corporations (e.g., ACME Corporation v. BETA Corporation) with different information technology infrastructures (e.g., network security protocols, firewalls), admin users (e.g., administrative users), information technology policies, and the like. An organization identifier can comprise ASCII text, a pointer, a memory address, and the like. A single organization can be associated with multiple workspaces within the group-based communication system 105. Thus, a given user can be associated with an organization identifier (i.e., for ACME Corporation) and multiple workspace identifiers (i.e., the engineering workspace, the new innovations workspace, etc.).

In some examples, each group can be associated with a workspace, associated with a workspace identifier. Users associated with the workspace identifier can chat, meet, call, collaborate, transfer files or other data, message, or otherwise communicate between or among each other in a secure and private virtual space available via the communication platform. In some examples, a workspace can be associated with multiple organizations.

In the context of shared resources as discussed herein, group identifiers can have two types: a host (e.g., owner) group identifier and a non-host group identifier. A host group identifier can be associated with the group that created the shared resource while a non-host group identifier can be associated with any group that joined the shared communication after it was created. As discussed in detail below, a shared resource can be associated with one or more non-host group identifiers but only one host group identifier. In an example where a group refers to an organization, a host organization identifier can be associated with the organization that created the shared resource while a non-host organization identifier can be associated with any organization that joined the shared communication after it was created. As discussed in detail below, a shared resource can be associated with one or more non-host organization identifiers but only one host organization identifier.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example environment 100 can include multiple (e.g., tens of, hundreds of, thousands of, millions of) user computing devices.

In at least one example, user computing devices, such as the user computing device 104, can be operable by users to, among other things, access communication services via the communication platform. A user can be an individual, a group of individuals, an employer, an enterprise, an organization, or the like. In some examples, users can be associated with designated roles (e.g., administrator, team leader, etc.) and/or types (e.g., verified, etc.). In at least one example, a user can be associated with a user identifier, which can comprise one or more items of data by which a user and the user's corresponding user profile can be identified within the communication platform. For example, a user identifier can comprise ASCII text, a pointer, a memory address, or other unique identifier. For the purpose of this discussion, a “user profile” can comprise information of the communication platform that is associated with a user, including, for example, a user identifier, a role identifier, one or more channel identifiers associated with channels that the user has been granted access to, one or more group identifiers for groups with which the user is associated, an indication as to whether the user is an owner or host of any channels, an indication as to whether the user has any channel restrictions, a plurality of messages, a plurality of emojis, a plurality of conversations, a plurality of conversation topics, an avatar, an email address, a real name (e.g., John Doe), a username (e.g., jdoe), a password, a real name, a time zone, a status, and the like. The user profile details can include a subset designation of user credentials, such as, for example, login information for the user including the user's username and password.

A role identifier, as used herein, can refer to one or more items of data by which a role of a user can be identified and is associated with a user profile. A role of a user can refer to the status of the user within the channel, the organization associated with the user or group, or other type of role. For example, a channel comprising users associated with a particular commercial organization can comprise roles such as “employee,” “associate,” “client,” “supervisor,” and the like. For example, a role identifier can comprise ASCII text, a pointer, a memory address, or other unique identifier.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

Data and information (including but not limited to, messages, search queries, etc.) can be sent to the server(s) 102 via, for example, the network(s) 106 directly by a user computing device, such as the user computing device 104. Additionally, or alternatively, data and information can be sent to the server(s) 102 via one or more intermediaries. That is, where a computing device is described herein to receive data from another computing device, it will be appreciated that the data can be received directly from another computing device or can be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data can be transmitted directly to another computing device or can be transmitted indirectly via one or more intermediary computing devices, such as, for example, one or more servers, relays, routers, network access points, base stations, hosts, and/or the like

In at least one example, the server(s) 102 can include one or more processors 108, computer-readable media 110, one or more communication interfaces 112, and input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a channel management component 116, an interface management component 118, an operating system 120, and a datastore 122. In some examples, the server(s) 102 can include additional or alternative functional components which can be used to manage additional or alternative resources (e.g., boards, workspaces, etc.), as described herein.

In at least one example, the channel management component 116 can manage channels of the communication platform. In at least one example, the communication platform can be “channel-based” such that the platform can be organized into channels having security (that can be defined by permissions) to limit access to defined groups of users (e.g., members of the channels). A channel, or virtual space, can be a data route used for exchanging data between and among systems and devices associated with the communication platform. In at least one example, a channel can be associated with a channel identifier. A channel identifier (e.g., group-based communication channel identifier) can include one or more items of data by which a channel can be identified. For example, a channel identifier can comprise ASCII text, a pointer, a memory address, and the like.

In at least one example, message communications can be exchanged via the communication platform (e.g., via channels, direct messages, and/or the like). A “message” or “message communication” can refer to any electronically generated digital object provided by a user using the user computing device 104 and that is configured for display within a channel and/or other virtual space for facilitating communications (e.g., a virtual space associated with direct message communication(s), etc.) as described herein. In some examples, messages can be automatically generated. A message can include any text, image, video, audio, or combination. In at least one example, a user can provide a message that includes text, as well as an image and a video, within the message as message contents. In such an example, the text, image, and video would comprise the message. Each message can include metadata comprising a sending user identifier (e.g., unique identifier (e.g., ASCII text, a pointer, memory address, etc.) indicating a user who composes and/or sends a message via the communication platform), a message identifier, message contents, a group identifier, a channel identifier, or the like. In some examples, message metadata also comprises a timestamp that identifies the time that a message was transmitted (i.e., sent) or posted to a channel, direct message, board, workspace, etc. In at least one example, each of the foregoing identifiers can comprise American Standard Code for Information Interchange (ASCII) text, a pointer, a memory address, or the like. Such message metadata can be used to index, render, query, or organize messages within the communication platform. In addition to message metadata, messages can also include body content data that comprises text, an image, a file, video, or the like. For example, as graphical objects are added or appended to a selected message communication (e.g., as emojis or reactions), the communication platform can add graphical object identifiers associated with such added graphical objects to the message metadata associated with the selected message.

In some examples, a channel can be “public,” which can allow any user within a group (e.g., associated with an organization identifier, associated with a workspace identifier, etc.) with which the channel is associated to join and participate in the data sharing through the channel. In some examples, a channel can be “private,” which can restrict data communications in the channel to certain users or users having particular roles (e.g., managers, administrators, etc.) and/or types (e.g., verified, etc.). In some examples, a channel can be “shared,” which can allow users associated with two or more different groups (e.g., entities associated with two or more different organization and/or workspace identifiers) to join and participate in the data sharing through the channel. A shared channel can be public such that it is accessible to any user of groups associated with the shared channel, or can be private such that it is restricted to access by certain users or users having particular roles and/or types. In some examples, a channel can be an “internal” channel indicating that the channel is associated with a single group.

A “shared channel,” which can also be referred to as an “externally shared channel,” can enable two or more organizations, such as a first organization and a second organization to share data, exchange communications, and the like. In an example, the first organization and the second organization can be associated with different organization identifiers, can be associated with different business entities, have different tax identification numbers, and/or otherwise can be associated with different permissions such that users associated with the first organization and users associated with the second organization are not able to access data associated with the other organization, without the establishment of a shared channel. In some examples, a shared channel can be shared with one or more different organizations that, without having a shared communication, would not otherwise have access to each other's data by the nature of the permission-based and/or group-based configuration of the communication platform described herein. In at least one example, the channel management component 116 can interact with the interface management component 118 to manage the generation, presentation, and/or updating of user interfaces associated with shared resources, such as shared channels. Additional details of operations that can be performed by the interface management component 118 are described below.

Additionally or alternatively, the channel management component 116 can cause a shared channel indicator to be presented in association with a shared channel via the user interface 130. In such examples, the shared channel may have associated therewith the shared channel indicator, while the internal and/or private channels do not include such an indicator. The shared channel indicator may include any type of shape or symbol, such as a diamond, a double diamond, a square, a circle, an exclamation mark, or the like. In some examples, the shared channel indicator can have data associated therewith that may be presented via the user interface responsive to receiving an indication that a user hovers over, right clicks, or otherwise requests to view the data. In some examples, the data may include a list of one or more organizations associated with the shared channel. In some examples, the one or more organizations can include organizations with an organization identifier that is different from an organization identifier associated with the user. For example, the communication platform may receive an indication that a controller (e.g., mouse, etc.) is hovering over a shared channel indicator. Responsive to the indication that the controller has been located over the shared channel indicator for greater than a threshold time, the communication platform can cause a list of one or more organizations associated with the shared channel to be presented via the user interface.

In some examples, the channel management component 116 can receive an indication of a selection (e.g., user selection input) of a particular channel. In some examples, the indication of selection of the particular channel can include a request to view data associated with the channel. In some examples, the channel management component 116 can identify one or more organization identifiers associated with the channel. In examples in which the channel is a non-shared channel, and thus has limited access to users associated with a particular organization, the channel management component 116 can interact with the interface management component 118 to cause data associated with the channel to be presented via the user computing device 104.

In some examples, the channel management component 116 can determine that the channel has associated therewith two or more organization identifiers and is thus a shared channel. In such examples, the channel management component 116 can determine the two or more identifiers associated with the shared channel and can interact with the interface management component 118 to cause a shared organization set interface 124 associated with the shared channel to be presented to via the user computing device 104. In some examples, the interface management component 118 can be configured to determine the shared organization set interface 124 associated with a particular shared channel. The shared organization set interface 124 can include visual depictions of the two or more organizations that have been validated for accessing (i.e., at least one user associated with each respective organization identifier is validated for accessing) the shared channel. A shared organization set interface 124 can visually depict member organizations using an array or collection of organization “indicators”, which include organization graphic identifiers such as logos, avatars, trademark designs, icons, colored shapes, and the like. In some examples, a shared organization set interface 124 can include an organization header 126 that includes member organization indicators positioned in a horizontally arranged pattern and/or an organization list 128 that includes member organization indicators positioned in a vertically arranged pattern.

In some examples, a shared organization set interface 124 can include member counts associated with each organization indicator that indicate the number of members associated with each respective organization that are validated for accessing a particular shared channel. In some examples, a shared organization set interface 124 can include organization indicators (and/or member counts) for organizations that have been invited for membership (i.e., at least one user associated with the organization identifier has been invited for membership) but which remain in a “pending status”, i.e., are awaiting validation for membership to a given shared channel. In some examples, responsive to receiving the indication of selection, the interface management component 118 can cause the shared organization set interface 124 be presented via the user computing device 104.

Additionally, the channel management component 116 can be configured to manage workspaces comprising one or more communication channels. The communication channel(s) can include shared and/or non-shared channels. That is, in some examples, the communication platform can be partitioned into different workspaces, which can be associated with different groups of users of the same or different organizations, as described above. Each workspace can be associated with a group identifier and one or more user accounts can be mapped to, or otherwise associated with, the group identifier. User(s) corresponding to such user account(s) can be “members” of the group. As described above, in some examples, workspaces can be associated with two or more organizations. In such examples, one or more members of each of the two or more organizations can communicate and collaborate via the workspace. In some examples, the interface management component 118 can determine a shared organization set interface associated with a particular workspace (e.g., based on a selection thereof) and can cause the shared organization set interface to be presented via the user computing device 104.

In some examples, the channel management component 116 can manage workspace membership. That is, the channel management component 116 can receive requests to associate users with individual workspaces and the channel management component 116 can associate user accounts associated with such users with group identifiers associated with the individual workspaces. For example, responsive to receiving a request to add a user to a workspace, the channel management component 116 can associate a user account of the user with a group identifier of the workspace. The channel management component 116 can disassociate user accounts and group identifiers, for example, when a user is removed from a workspace. In at least one example, the channel management component 116 can interact with the interface management component 118 to cause a display of indicators appropriate for selected workspaces and/or communication channels.

In at least one example, the channel management component 116 can manage cross-workspace data integration, as described herein. For example, the workspace management component 116 can detect updates to data associated with a workspace and can integrate such updated data into user interface(s) presented via user computing device(s) of user(s) associated with the workspace. Such data integration can be “cross-workspace” such that, regardless of which workspace a user is logged in to, the user can receive updated data associated with each of the workspaces of which he or she is a member and/or access data associated with each of the workspaces of which he or she is a member (pending permissions, as described below). That is, the channel management component 116 can detect updates to data associated with a workspace and can integrate such updated data into user interface(s) presented via user computing device(s) of user(s) associated with the workspace. Similarly, the channel management component 116 can facilitate cross-workspace operations. For example, the channel management component 116 can facilitate messages between workspaces, searches between or across multiple workspaces, and the like.

In at least one example, the interface management component 118 can be configured to generate, update, and provide user interfaces 130 to enable users to communicate via the communication platform. In various examples, the interface management component 118 can be configured to determine a shared organization set interface 124 associated with a selected shared channel. As discussed above, the shared organization set interface 124 can include an organization header 126 and/or an organization list 128. In some examples, the organization header 126 and/or the organization list 128 can include a status identifier associated with each associated organization. The status identifier can include an indication of whether the organization is an owner (e.g., initiator, primary organization, etc.) associated with the shared channel, a member (e.g., associated with member-related access privileges), a guest organization (e.g., organization with limited access to view and/or contribute data via the shared channel), or the like. In some examples, the organization header 126 and/or the organization list 128 can include a member count associated with an organization. The member count can represent a number of members of a particular organization that have access to the shared channel.

In at least one example, the operating system 120 can manage the processor(s) 108, computer-readable media 110, hardware, software, etc. of the server(s) 102.

In at least one example, the datastore 122 can be configured to store data that is accessible, manageable, and updatable. In some examples, the datastore 122 can be integrated with the server(s) 102, as shown in FIG. 1. In other examples, the datastore 122 can be located remotely from the server(s) 102 and can be accessible to the server(s) 102 and/or user device(s), such as the user device 104. The datastore 122 can comprise multiple databases. Additional or alternative data may be stored in the data store and/or one or more other data stores.

In some examples, the datastore 122 can include user data. The user data can include data associated with users of the communication platform, such as user profiles (which can also be referred to as “user accounts”), one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In some examples, the datastore 122 can include permission data. The permission data can include data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. In some examples, permissions associated with an individual user can be mapped to, or otherwise associated with, an account or profile associated with the user data. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In some examples, data associated with one or more administrative accounts corresponding to organizations can be stored in the datastore 122. In various examples, an administrator, or administrative user (e.g., admin user) can include a subscriber of a channel or workspace who has authority to manage the group-based communication channel or workspace and associated resources and make decisions on behalf of other subscribers regarding various maintenance tasks. For example, an admin user may have the authority to set a communication channel as either “public” or “private.” As another example, when receiving a request to create a shared channel or other shared resource, only an admin user has the authority to accept the request on behalf of the group and/or organization.

In some examples, the datastore 122 can include workspace data. The workspace data can include data associated with individual workspaces (e.g., collections of channels). As described above, the communication platform can be partitioned into workspaces associated with groups of users. In at least one example, a group identifier can be associated with a workspace. In at least one example, the group identifier can indicate a physical address in the datastore 122 where data related to the corresponding workspace is stored. In at least one example, data associated with workspace permissions can be stored in association with the group identifier, data identifying users associated with the workspace can be stored in association with the group identifier, data associated with messages and/or other content associated with the workspace can be stored in association with the group identifier, data associated with communication channels associated with the workspace can be stored in association with the group identifier, and the like. In some examples, workspaces can be associated with one or more organization identifiers, which can be associated with organizations or other entities associated with the communication platform. In some examples, such data can be mapped to, or otherwise associated with, other types of data in the datastore 122.

In some examples, the datastore 122 can include channel data. The channel data can include data associated with individual communication channels. In at least one example, the channel management component 116 can establish a communication channel between and among various user computing devices, allowing the user computing devices to communicate and share data between and among each other. In at least one example, a communication channel identification may be assigned to a communication channel, which indicates the physical address within the datastore 122 where the channel data related to that communication channel is stored.

In some examples, the datastore 122 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 122 that stores data related to a particular organization identification. For example, a database shard can store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared channel).

In some examples, individual groups can be associated with a database shard within the datastore 122 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a communication channel can be associated with a database shard within the datastore 122 that stores data related to a particular channel identification. For example, a database shard may store electronic communication data associated with the communication channel, which enables members of that particular communication channel to communicate and exchange data with other members of the same communication channel in real time or near-real time. In this example, a group or organization can be the owner of the database shard and can control where and how the related data is stored.

In some examples, individual users can be associated with a database shard within the datastore 122 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via Websockets, Application Programming Interfaces (APIs) (e.g., using API calls), HypterText Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 132, computer-readable media 134, one or more communication interfaces 136, and input/output devices 138.

In at least one example, each processor of the processor(s) 132 can be a single processing unit or multiple processing units, and can include single or multiple computing units or multiple processing cores. The processor(s) 132 can comprise any of the types of processors described above with reference to the processor(s) 108 and may be the same as or different than the processor(s) 108.

The computer-readable media 134 can comprise any of the types of computer-readable media 134 described above with reference to the computer-readable media 110 and may be the same as or different than the computer-readable media 110. Functional components stored in the computer-readable media can optionally include at least one application 140 and an operating system 142.

In at least one example, the application 140 can be a mobile application, a web application, or a desktop application, which can be provided by the communication platform or which can be an otherwise dedicated application. In some examples, individual user computing devices associated with the environment 100 can have an instance or versioned instance of the application 140, which can be downloaded from an application store, accessible via the Internet, or otherwise executable by the processor(s) 132 to perform operations as described herein. That is, the application 140 can be an access point, enabling the user computing device 104 to interact with the server(s) 102 to access and/or use communication services available via the communication platform. In at least one example, the application 140 can facilitate the exchange of data between and among various other user computing devices, for example via the server(s) 102. In at least one example, the application 140 can present user interfaces, as described herein. In at least one example, a user can interact with the user interfaces via touch input, keyboard input, mouse input, spoken input, or any other type of input.

In at least one example, the application 140 can be an access point, enabling the user computing device 104 to interact with the server(s) 102 to access and/or use communication services available via the communication platform. In some examples, the application 140 can be a web browser by which a user can access communication services provided by the communication platform as described herein. In some examples, the application 140 can be a dedicated application associated with the communication platform as described herein. In at least one example, the application 140 can facilitate the exchange of data between and among various other user computing devices, for example via the server(s) 102. In at least one example, the application 140 can present user interface(s), as described herein. In at least one example, a user can interact with the user interface(s) via touch input, keyboard input, mouse input, spoken input, or any other type of input.

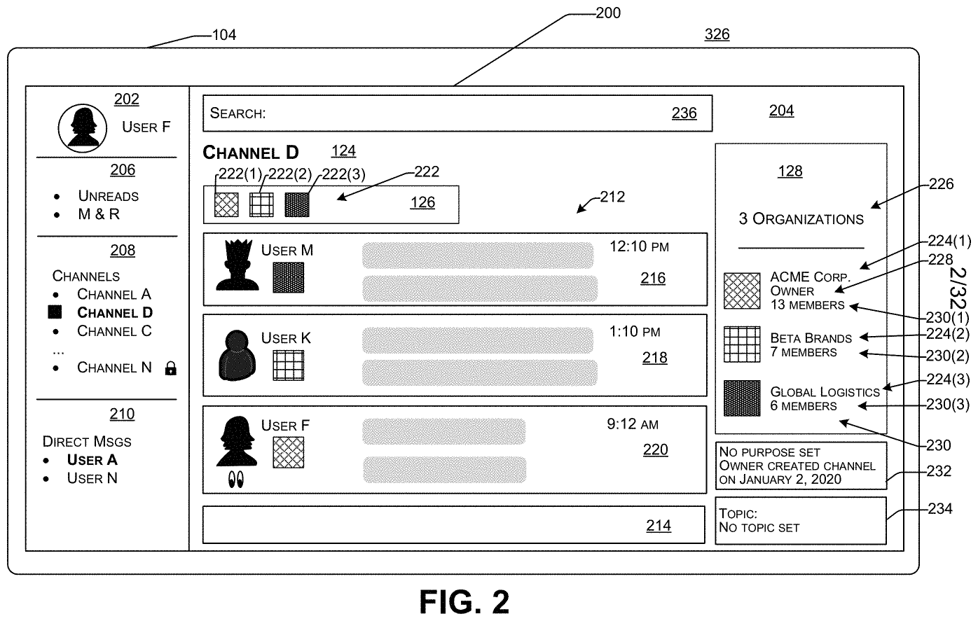

A non-limiting example of a user interface 130 is shown in FIG. 1. As illustrated in FIG. 1, the user interface 130 can present data associated with one or more communication channels and, in some examples, one or more workspaces. Additional details associated with the user interface 130 are described below with reference to FIG. 2. In at least one example, the user interface can present a shared organization set interface 124 to be presented via the user interface 130. As discussed above, shared organization set interface 124 can be associated with a shared communication channel having associated therewith two or more organizations. In various examples, the indicators associated with the two or more organizations can be presented in the organization header 126 and/or organization list 128. In some examples, indicators associated with the two or more organizations may be presented in association with each message posted via the shared channel, such as to provide a visual depiction of an organization associated with the sender (e.g., user) of the message.

In at least one example, the operating system 142 can manage the processor(s) 132, computer-readable media 134, hardware, software, etc. of the server(s) 102.

The communication interface(s) 136 can include one or more interfaces and hardware components for enabling communication with various other devices (e.g., the user computing device 104), such as over the network(s) 106 or directly. In some examples, the communication interface(s) 136 can facilitate communication via Websockets, APIs (e.g., using API calls), HTTPs, etc.

The user computing device 104 can further be equipped with various input/output devices 138 (e.g., I/O devices). Such I/O devices 138 can include a display, various user interface controls (e.g., buttons, joystick, keyboard, mouse, touch screen, etc.), audio speakers, connection ports and so forth

While techniques described herein are described as being performed by the channel management component 116, the interface management component 118, and the application 140, techniques described herein can be performed by any other component, or combination of components, which can be associated with the server(s) 102, the user computing device 104, or a combination thereof.

FIG. 2 illustrates an example user interface 200 that can be presented via a user computing device, as described herein. The user interface 200 can correspond to the user interface 130 described above with reference to FIG. 1. In at least one example, the user interface 200 can be associated with the communication platform, described above. That is, in at least one example, the server(s) 102 can send instructions to the user computing device 104 for presenting the user interface 200 via an application. The user interface 200, which can be referred to as a “group-based communication interface,” can refer to a graphical user interface that can be configured to allow users to view and engage with the communication platform.

In at least one example, the user interface 200 can present data associated with one or more channels. In some examples, the user interface 200 can be a “channel-based” user interface. In some examples, the user interface 200 can include a first section 202 (e.g., which can be a portion, pane, or other partitioned unit of the user interface 200), that includes indicator(s) (e.g., user interface element(s) or object(s)) representing data associated with channel(s), direct message(s), etc. with which the user (e.g., account of the user) is associated. In at least one example, the user interface 200 can include a second section 204 (e.g., which can be a portion, pane, or other partitioned unit of the user interface 200) that, in some examples, can be associated with a data feed (or, “feed”) indicating messages posted to and/or actions taken with respect to one or more channels and/or other virtual spaces for facilitating communications (e.g., a virtual space associated with direct message communication(s), a virtual space associated with event(s) and/or action(s), etc.) as described herein. In at least one example, data associated with the second section 204 can be associated with the same or different workspaces. That is, in some examples, the second section 204 can present data associated with the same or different workspaces via an integrated feed. In some examples, the data can be organized and/or is sortable by date, time (e.g., when associated data is posted or an associated operation is otherwise performed), type of action and/or data, workspace, channel, user, topic, relevance metric, and/or the like. In some examples, such data can be associated with an indication of which user (e.g., member of the channel) posted the message and/or performed an action. In examples where the second section 204 presents data associated with multiple workspaces, at least some data can be associated with an indication of which workspace the data is associated with.

In some examples, the first section 202 can be referred to as a “channel list pane” and, in some examples, it can be configured to display lists of channels. In some examples, as described below, such channels can include shared resources. As described below, the first section 202 can be configured to display lists of additional or alternative virtual spaces and/or resources. In some examples, the second section 204 can be referred to as a “message pane” and can be configured to display one or more messages of a channel upon user selection of a channel from the channel list pane. As described below, the second section 204 can display additional or alternative data or information (e.g., beyond messages).

In at least one example, the first section 202 can include one or more sub-sections, which can represent different virtual spaces. For example, a first sub-section 206 can include indicators representing virtual spaces that can aggregate data associated with a plurality of channels and/or workspaces. In at least one example, each virtual space can be associated with an indicator in the first sub-section 206. In some examples, an indicator can be associated with an actuation mechanism, that when actuated, can cause data associated with the corresponding virtual space to be presented via a second section 204 of the user interface 200. In some examples, instead of presenting the data associated with the corresponding virtual space via the second section 204, such data can be presented via another user interface presented via another application, as described herein.

In at least one example, a virtual space can be associated with all unread data associated with each of the workspaces with which the user is associated. That is, in some examples, if the user requests to access the virtual space associated with “unreads,” all data that has not been read (e.g., viewed) by the user can be presented in the second section 204, for example in a feed. In another example, “threads” can be associated with messages, files, etc. posted in threads to messages posted in a channel and/or a virtual space associated with “mentions and reactions” (e.g., “M & R”) can be associated with messages or threads where the user (e.g., User F) has been mentioned (e.g., via a tag) or another user has reacted (e.g., via an emoji, reaction, or the like) to a message or thread posted by the user. In some examples, if the user requests to access the virtual space associated with “snippets of content,” snippets of content associated with the user, which can be associated with different channels and/or virtual spaces, can be presented via a same feed. In some examples, such data can be organized and/or is sortable by date, time (e.g., when associated data is posted or an associated operation is otherwise performed), type of action and/or data, workspace, channel, user, topic, relevance metric, and/or the like. In some examples, such data can be associated with an indication of which user (e.g., member of the channel) posted the message, performed an action, and/or the like. Additional details are described below.

In at least one example, the first section 202 of the user interface 200 can include a second sub-section 208 that includes indicators representing channels. In some examples, the channels can include public channels, private channels, shared channels (e.g., between workspaces or organizations), internal channels (e.g., single workspace channels), cross-workspace channels, combinations of the foregoing, or the like. In some examples, the channels represented can be associated with a single workspace. In some examples, the channels represented can be associated with different workspaces (e.g., cross-workspace). In some examples, the channels represented can be associated with combinations of channels associated with a single workspace and channels associated with different workspaces.

In some examples, the second sub-section 208 can depict all channels, or a subset of all channels, that the user has permission to access (e.g., as determined by channel data and/or permission data). In such examples, the channels can be arranged alphabetically, based on most recent interaction, based on frequency of interactions, based on channel type (e.g., public, private, shared, cross-workspace, etc.), based on workspace, in user-designated sections, or the like. In some examples, the second sub-section 208 can depict all channels, or a subset of all channels, that the user is a member of, and the user can interact with the user interface 200 to browse or view other channels that the user is not a member of but are not currently displayed in the second sub-section 208. In some examples, different types of channels (e.g., public, private, shared, etc.) can be in different sections of the second sub-section 208, or can have their own sub-sections or sub-sections in the user interface 200. In some examples, channels associated with different workspaces can be in different portions of the second sub-section 208, or can have their own sections or sub-sections in the user interface 200.

In some examples, channels can be organized in list form within the channel list pane of the user interface based on group-defined titles. A “group-defined title” can refer to a channel name or text string that can be conceived and stored at the time a channel is created for common identification to all members of the channel. In some examples, group-defined titles are created based on a group-wide nomenclature/procedure so that group members can readily understand the purpose of any associated channel. Example group-defined titles include: #accounting—audit 2019, #accounting—payroll, #HR—onboarding procedure, #food truck frenzy, and the like. A shared resource can have a unique group-defined title for each user identifier and/or organization identifier associated with the shared resource.

In some examples, the indicators can be associated with user interface elements that visually differentiate types of channels. For example, Channel D is associated with a square user interface element instead of a circle user interface element. As a non-limiting example, and for the purpose of this discussion, the square user interface element can indicate that the associated channel (e.g., Channel D) is a shared channel. In some examples, such a user interface element can be the same for all shared channels. In other examples, such a user interface element can be specific to the other group with which the shared channel is associated. In some examples, additional or alternative graphical elements can be used to differentiate between public channels, private channels, shared channels, channels associated with different workspaces, and the like. In other examples, channels that the user is not a current member of may not be displayed in the second sub-section 208 of the user interface 200. In such examples, the user can navigate to a different interface to browse additional channels that are accessible to the user but to which the user is not currently a member.

In addition to the second sub-section 208, the first section 202 can include a third sub-section 210 that can include indicators representative of direct messages. That is, the third sub-section 210 can include indicators representative of virtual spaces that are associated with private messages between one or more users.

As described above, in at least one example, the user interface 200 can include a second section 204 that, in some examples, can be associated with a feed indicating messages posted to and/or actions taken with respect to a channel and/or other virtual space (e.g., a virtual space associated with direct message communication(s), a virtual space associated with event(s) and/or action(s), etc.) for facilitating communications. As described above, in at least one example, data associated with the second section 204 can be associated with the same or different workspaces. That is, in some examples, the second section 204 can present data associated with the same or different workspaces via an integrated feed. In some examples, the data can be organized and/or is sortable by date, time (e.g., when associated data is posted or an associated operation is otherwise performed), type of action and/or data, workspace, channel, user, topic, relevance metric, and/or the like. In some examples, such data can be associated with an indication of which user posted the message and/or performed an action.

A channel or other virtual space can be associated with data and/or content other than messages, or data and/or content that is associated with messages. For example, non-limiting examples of additional data that can be presented via the second section 204 of the user interface 200 include members added to and/or removed from the channel, file(s) (e.g., file attachment(s)) uploaded and/or removed from the channel, application(s) added to and/or removed from the channel, post(s) (data that can be edited collaboratively, in near real-time by one or members of a channel) added to and/or removed from the channel, description added to, modified, and/or removed from the channel, modifications of properties of the channel, etc. In some examples, objects, as described above, can be associated with a channel or other virtual space (e.g., a direct message, board, etc.). In some examples, individual objects can be referenced in the second section 204. In some examples, individual objects can be associated with an actuation mechanism, such as a link.

In some examples, the second section 204 can be associated with a virtual space that can be associated with a board. In some examples, a board can be accessed from one of the sub-sections 206-210 and/or via another user interface element. A board, which can be an “electronic board,” can be a virtual space, canvas, page, or the like for collaborative communication and/or organization within the communication platform. In at least one example, a board can support editable text and/or objects that can be ordered, added, deleted, modified, and/or the like. In some examples, a board can be associated with permissions defining which users of a communication platform can view and/or edit the board. In some examples, a board can be associated with a channel and at least some members of the channel can view and/or edit the board. In some examples, a board can be sharable such that data associated with the board is accessible to and/or interactable for members of the multiple channels, workspaces, organizations, and/or the like.

In at least one example, a board can include section(s) and/or object(s). In some examples, each section can include one or more objects. In some examples, the sections and/or objects can be reordered and/or otherwise rearranged, new sections and/or objects can be added or removed, and/or data associated with such sections and/or objects can be edited and/or modified. That is, boards can be created and/or modified for various uses. That is, users can customize and/or personalize boards to serve individual needs as described herein. As an example, sections and/or objects can be arranged to create a project board that can be used to generate and/or assign tasks, track progress, and/or otherwise manage a project. Further, in some examples, boards can present company metrics and also enable access to company goals so that such information can be stored and/or accessed via a single location. In some examples, boards can be used to keep track of work progress and/or career growth, which can be used by managers or supervisors for managing and/or supervising employees, agents, and/or other workers. In at least one example, a board can be used to track incidents, incoming customer service requests, and/or the like.

In some examples, as illustrated in FIG. 2, the second section 204 can comprise a feed associated with a single channel (e.g., Channel D). In such examples, data associated with the channel can be presented via the feed. In at least one example, data associated with a channel can be viewable to at least some of the users of a group of users associated with a same group identifier. In some examples, for members of a channel, the content of the channel (e.g., messages and/or objects) can be displayed to each member of the channel. For instance, a common set of group-based messages can be displayed to each member of the channel such that the content of the channel (e.g., messages and/or objects) may not vary per member of the channel. In some examples, messages associated with a channel can appear differently for different users (e.g., based on personal configurations, group membership, permissions, policies, etc.).

In at least one example, the format of the individual channels or virtual spaces can appear differently to different users (e.g., based on personal configurations, group membership, permission(s), etc.). In some examples, the format of the individual channels or virtual spaces can appear differently based on which workspace or organization a user is currently interacting with or most recently interacted with. In at least one example, a common set of messages can be displayed, via a respective instance of the user interface 200, to each member of the respective channel such that the content of the channel (e.g., messages) may not vary per member of the channel except through application of organization-based information technology policies, such as data retention policies.

In at least one example, the format of an individual channel may appear differently based on a determination that the channel is a shared channel. As discussed above, responsive to receiving an indication of selection of a shared channel, such as Channel D, the communication platform can identify two or more organizations associated with the shared channel. In some examples, the organizations can be identified based on two or more organizational identifiers associated with the selected shared channel. In various examples, the communication platform can identify the organization(s) and can cause a shared organization set interface comprising data corresponding to the shared channel. The shared organization set interface can be presented via the second section 204 and can include one or more of an organization header 126, an organization list 128, and/or a messaging pane 212.

In the illustrative example, the shared organization set interface 124 can include an organization header 126 located above the messaging pane 212. In some examples, the organization header 126 can be located in another location in the second section 204, such as above a input mechanism 214 and below one or more user interface elements 216, 218, and 220. The organization header 126 can include one or more organizational indicators 222 associated with each organization corresponding to the shared channel. For example, a shared channel, such as Channel D, can have associated therewith three organizations. The organization header 126 can thus include a first organizational indicator 222(1) can be associated with a first organization, a second organizational indicator 222(2) can be associated with a second organization and a third organizational indicator 222(3) can be associated with a third organization. Though illustrated as boxes including different shading to illustrate the different organizations, this is not intended to be so limiting and the organizational indicators 222 may include any other type of indicator, such as a company or organizational logo, design, color, shape, shading, or the like.

Additionally or alternatively, the shared organization set interface 124 can include an organization list 128. In various examples, the organization list 128 may provide a list of the different organizations 224 associated with the shared channel. In at least one example, the communication platform can determine the organizations 224 and/or data associated therewith based on the organizational identifiers.

In some examples, the organization list 128 may provide a total count 226 of the number of organizations 224 associated with the shared channel. The total count 226 may provide users with a visual depiction of a total number of different organizations that may view content published via the shared channel. In various examples, the organization list 128 may include a list of each organization 224(1), 224(2), and 224(3) and/or data associated with respective organizations 224. As a non-limiting example, the data can include a status identifier 228 associated with at least one organization 224. The status identifier 228 can include an indication of whether the organization 224 is an owner (e.g., initiator, primary organization, etc.) associated with the shared channel, a member (e.g., associated with member-related access privileges), a guest organization (e.g., organization with limited access to view and/or contribute data via the shared channel), or the like. For example, the first organization 224(1) includes a status identifier 228 of an owner, indicating that the first organization 224(1) generated the shared channel and is generally responsible for the administration thereof (e.g., authorizing new members to join, managing content, managing a data retention policy, etc.).

In some examples, the data can include a member count 230 associated with each organization. The member count 230 can represent a number of members of a particular organization that have access to (e.g., permissions to interact with content associated with) the shared channel. For example, a first member count 230(1) associated with the first organization 224(1) indicates that thirteen (13) members of the first organization 224(1) have access to the shared channel, a second member count 230(2) associated with the second organization 224(2) indicates that seven (7) members of the second organization 224(1) have access to the shared channel, and a third member count 230(3) associated with the third organization 224(3) indicates that six (6) members of the third organization 224(3) have access to the shared channel.

In various examples, the member count 230 can include a selectable control. In such examples, responsive to receiving an indication of selection of the member count 230 (e.g., click, hovering over the member count 230 for a threshold amount of time, etc.), the communication platform can cause data associated with the members to be presented via the user interface. In some examples, the data can include a list of each of the members associated with the organization that are also associated with the shared channel. For example, responsive to receiving an indication of selection of the first member count 230(1), the communication platform can cause names (e.g., username, real name, etc.) to be presented in a list of members via the user interface.

In some examples, the list of the members can include selectable options associated with each member in the list. In such examples, responsive to receiving an indication of selection of a member name, the communication platform can provide access to profile information associated with the selected member. The profile information can include an associated organization, time the member has been associated with the shared channel and/or organization, contact information (e.g., telephone number, address, handle, etc.), and the like. In some examples, the communication platform can enable the user to contact the selected member, such as via a message (e.g., direct message, text (SMS) message, etc.) or a call (e.g., telephone call, VoIP, etc.). For example, the contact information associated with the member can include a link to send a message to the member, such as via a direct message instance. Responsive to receiving an indication of selection of the link, the communication platform can cause an interface associated with a direct messaging instance to be presented via the user interface.

In some examples, the organization set interface 124 can include a description field 232 providing additional data associated with the shared channel. As a non-limiting example, the description field 232 can include a purpose of the channel (e.g., reason for collaboration between the organizations), a goal associated with the shared channel, a date and/or time the shared channel was created, and the like. In some examples, the organization set interface 124 can include a topic field 234. The topic filed can include topics associated with the shared channel.

Additionally, and as will be described below, in some examples, the organization set interface 124 can include an operation menu configured to provide one or more operation options associated with the shared channel. The operation options can include setting notifications, adding members, and the like.

As illustrated in FIG. 2, the user can interact with the user interface element that corresponds to Channel D in the second sub-section 208 and as such, a feed associated with the channel can be presented via the second section 204 of the user interface. As discussed above, the communication platform can identify data associated with the channel based on a channel identifier and organizational identifiers associated therewith. As depicted in FIG. 2, the second section 204 can include user interface elements 216, 218, and 220 which each represent messages posted to the channel. As illustrated, the user interface elements 216-220 can include an indication of a user who posted the message, a time when the message was posted, content associated with the message, reactions associated with the message, and/or the like. In at least one example, the user interface elements 216, 218, and 220 can each include organizational indicators 222, to provide the user with a clear indication of an organization associated with the user who posted the message. As discussed above, the second section 204 can include an input mechanism 214, which can be associated with a message composition user interface to enable a user to compose a message to be posted to the channel.

In at least one example, the user interface 200 can include a search mechanism 236, wherein a user can input a search term and the server(s) 102 can perform a search associated with the communication platform. In some examples, the search can be performed across each group with which the user is associated, or the search can be restricted to a particular group, based on a user specification.

In various examples, user access to a particular shared channel can be determined based on one or more policies associated with the shared channel, an organization of the user, a user account type (e.g., full account, limited access account, etc.), or the like. The “policies” can refer to one or more rules, permissions, security agreements, and/or the like, which in some examples, can be associated with a channel identifier, a group identifier (e.g., a workspace identifier, an organization identifier, etc.), and/or the like. Policies can be determined by an organization (e.g., associated with an organization identifier) and/or users (e.g., admin or non-admin users) associated with an organization. In some examples, an organization or users (e.g., admin or non-admin users) can determine policies when a channel, direct message, board, workspace, etc. is created or at a later time. In at least one example, data associated with policies can indicate which members of a channel are permitted to perform certain actions, such as post messages to the channel, share files, invite new members, and/or the like. In at least one example, a data associated with policies can indicate retention policy settings, which can implement a data retention policy. Retention policy settings can be established by an admin user accessing the communication platform. For example, a host admin user associated with a group-based resource can establish host retention policy settings for the group-based resource. In another example, non-host admin users associated with a shared resource can establish retention policy settings that are applicable to message data posted by their respective groups or organizations.

In at least one example, the data associated with the policies can indicate which members of a channel are permitted to invite new users associated with different organizations. In some examples, a member of a host organization can establish a policy that members of a shared channel that are associated with non-host organizations can invite users associated with other non-host organizations to join the shared channel. In some examples, based on the policy, the communication platform can generate and send a message to each member of the shared channel indicating that the member can invite other users (e.g., additional organizations) to join the shared channel. In such examples, the members can be informed as to the policy regarding inviting other organizations and/or other users to join the shared channel. In some examples, the member of the host organization can indicate that select members of the other organizations can be authorized to invite other users and/or other organizations. In such examples, the communication platform can send the message to the select members informing them of the authorization to invite other users and/or other organizations.

In various examples, the communication platform can enable members to invite other users and/or organizations to the shared channel. In some examples, the communication platform can generate an invitation based on receiving a request for an invitation from a member authorized to invite other users. In some examples, the communication platform can generate the invitation based on a determination that less than a threshold number of different organizations are associated with the communication channel. In some examples, the invitation may have associated therewith a validation time period. The validation time period can represent a period of time in which the invitation may be accepted by a receiving user. For example, an invitation to join a shared channel can include a validation time period of seven (7) days. Responsive to receiving an indication of selection by the receiving user within seven days, the communication platform can associate the receiving user and an associated organization with the shared channel. Responsive to receiving an indication of selection of the receiving user after an expiration of the validation time period (e.g. on the eight (8) day), the communication platform can present an indication of invalidity of the invitation on a user interface associated with the receiving user.

In various examples, the policy enabling other members to invite other users can include a requirement that an acceptance of an invitation to join the shared channel by another user be authorized by a member of the host organization or an administrative user associated with an organization of the other user. In some examples, responsive to receiving an indication of acceptance of the invitation from the other user, the communication platform can send a message to the administrative user requesting a confirmation of the other user joining the shared channel. Based on receiving the confirmation from the administrative user, the communication platform can associate the other user and/or the organization of the other user with the shared channel.

It is noted that the scope of the present disclosure is not limited to the example user interfaces as described and illustrated herein, and the scope of the present disclosure can encompass various variations of the example user interfaces. For example, one or more elements can be added to and/or removed from these example user interfaces. Additionally, or alternatively, the position(s) of one or more elements can be adjusted and/or rearranged. Additionally, or alternatively, texts, graphics, and/or the like can be added to, removed from, and/or adjusted for these example user interfaces.

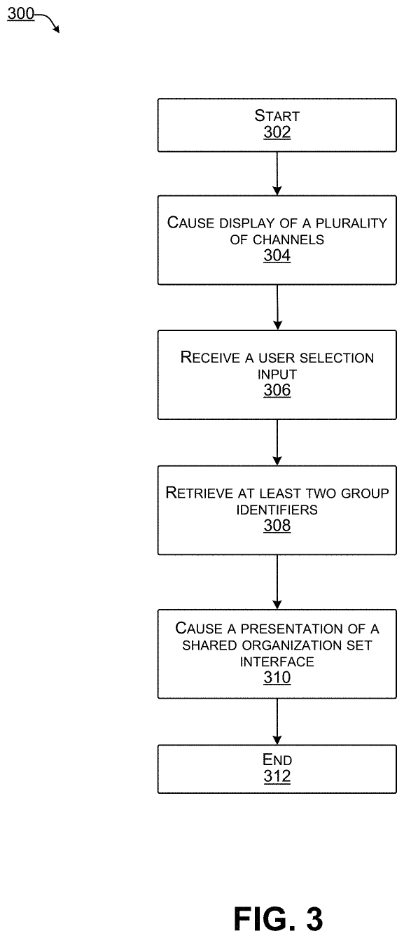

Various methods and user interfaces described herein, including, for example, those as shown in FIGS. 3-55, may provide and/or update group-based communication interfaces associated with a communication platform, such as that described above with regard to FIGS. 1 and 2.

It is noted that each block of the flowchart, and combinations of blocks in the flowchart, may be implemented by various means such as hardware, firmware, circuitry and/or other devices associated with execution of software including one or more computer program instructions. For example, one or more of the procedures described in these figures may be embodied by computer program instructions, which may be stored by a non-transitory memory of an apparatus employing an example of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

It is noted that the scope of the present disclosure is not limited to the example user interfaces as described and illustrated herein, and the scope of the present disclosure may encompass various variations of these example user interfaces. For example, one or more elements may be added to and/or removed from these example user interfaces. Additionally, or alternatively, the position(s) of one or more elements may be adjusted and/or rearranged. Additionally, or alternatively, texts, graphics, and/or the like may be added to, removed from, and/or adjusted for these example user interfaces.

### Shared Organization Set Interface

FIG. 3 depicts an example method 300 structured in accordance with one example. In particular, the example method 300 illustrates examples of updating a user interface (e.g., group-based communication interface) to display a shared organization set interface associated with a communication platform.

The example method 300 may start at block 302. At block 304, the communication platform (e.g., one or more server(s) 102) may cause display of a plurality of channels. In some examples, channel titles associated with the plurality of channels may be displayed is list format in a channel list pane of the user interface.

In some examples, the plurality of channels can include at least one shared channel. As described above, a shared channel or “externally shared communication channel” refers to a communication channel having members affiliated with different organizations or commercial enterprises. For example, members of the shared channel may be associated with different organization identifiers. In some examples, when members of a shared channel are associated with three or more organization identifiers, the shared channel may also be referred to as a “multi-organization channel.”

In some examples, the plurality of channels may comprise at least one internal channel. An internal channel or “internally shared group-based communication channel” refers to a communication channel having members affiliated with the same organization or commercial enterprise. For example, members of the internal channel may be associated with the same organization identifier.

In some examples, the channel list pane may comprise an externally shared portion and an internally shared portion. The externally shared portion may be configured to display shared channels including the at least one shared channel. The internally shared portion may be configured to display internal channels including the at least one internal channel.

At block 306, the communication platform can receive a user selection input associated with the at least one shared channel. In some examples, the user selection input may be generated via an input device associated with a user computing device, such as user computing device 104. For example, the user selection input may be generated by a mouse click, a keystroke on a keyboard, a tap on a touch screen, and/or the like. The user selection input may be associated with a channel title in the channel list pane, such as a channel title in the externally shared portion.

A block 308, the communication channel can retrieve at least two organization identifiers associated with the selected at least one shared channel. Based on the retrieved data, the communication platform can determine two or more organization identifiers associated with the shared channel. As described above, each organization identifier can include data that uniquely identifies an organization associated with the communication platform.

At block 310, the communication platform can cause a presentation of a shared organization set interface, such as organization set interface 124 on a user interface, such as user interface 130 of the user computing device, based at least in part on the retrieved at least two organization identifiers. The shared organization set interface can include an interface element that visually depicts organizations that have been validated for accessing (i.e., at least one user associated with each respective organizational identifier is validated for accessing) the shared channel. The shared organization set interface can include member organizations using an array or collection of organization “indicators,” which include organization graphic identifiers such as logos, avatars, trademark designs, icons, colored shapes, and the like. In one example, a shared organization set interface can include an “organization header” that includes member organization indicators positioned in a horizontally arranged pattern. In some examples, a shared organization set interface can include an “organization list” that includes member organization indicators positioned in a vertically arranged pattern. In some examples, a shared organization set interface can include member counts associated with each organization indicator that indicate the number of members associated with each respective organization that are validated for accessing the shared channel in question. In some examples, a shared organization set interface can include organization indicators (and/or member counts) for organizations that have been invited for membership (i.e., at least one user associated with the organization identifier has been invited for membership) but which remain in a “pending status”, i.e., are awaiting validation for membership to a given shared channel.

In some examples, subsequent to receiving a user selection input, the communication platform can update the user interface, and can cause a rendering of a shared organization set interface associated with the corresponding group-based communication channel that is selected by the user. In some examples, the shared organization set interface can be generated based on, for example, the organization identifiers retrieved by the communication at block 308.

The example method 300 may end at block 312.

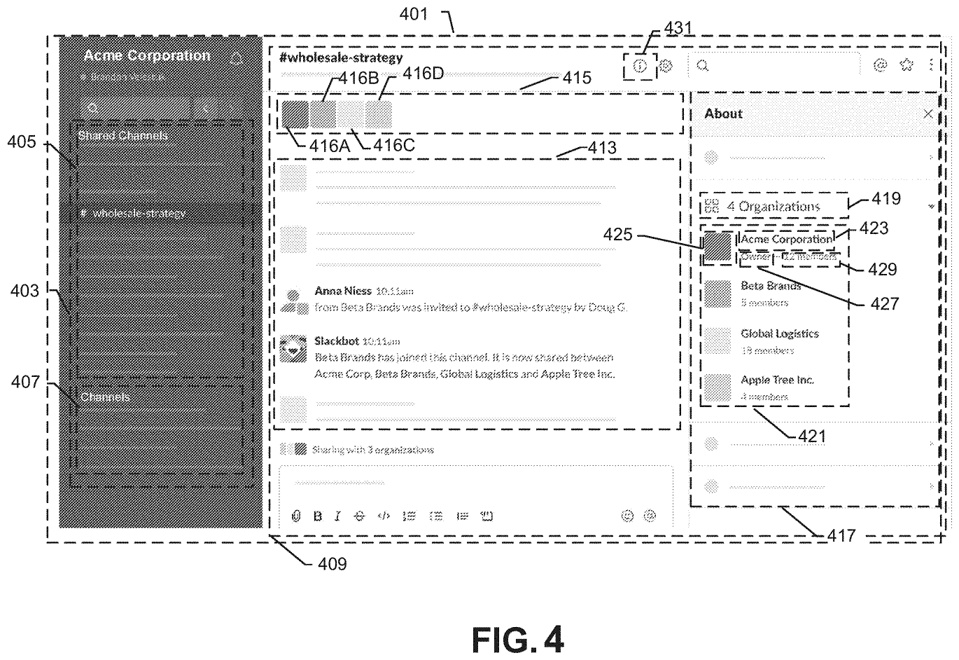

Referring now to FIG. 4, an example user interface 401 is provided. In particular, the example user interface 401 can be rendered on a display of a user computing device, such as user computing device 104. For example, the user interface 401 can be rendered on a display of a user computing device associated with a user Brandon, who may be a member of the organization ACME Corporation.

The depicted user interface 401 of FIG. 4 includes a channel list pane 403. In some examples, the channel list pane 403 may be positioned on the leftmost side of the user interface 401, thereby allowing a user to intuitively navigate various channels associated with the user interface 401. In some examples, the channel list pane 403 may be positioned at other locations within the user interface 401, without deviating from the scope of the present disclosure. In the illustrative example, the channel list pane 403 includes an externally shared portion 405 and an internally shared portion 407. The externally shared portion 405 includes a list of channel titles associated with shared channels that a user associated with the user interface 401 is a member of. For example, the externally shared portion 405 can include a channel title for the #wholesale-strategy shared channel. The internally shared portion 407 includes a list of channel titles associated with internal communication channels that a user (e.g., Brandon) associated with the user interface 401 is a member of.

In some examples, Brandon may select (e.g., by taping a touch screen) the channel title associated with the #wholesale-strategy shared channel thereby generating a user selection input or indication of selection of a shared channel.

In response to receiving Brandon's user selection input associated with the #wholesale-strategy shared channel, the communication platform determines a channel identifier associated with the #wholesale-strategy shared channel. Based on the channel identifier, the communication platform can retrieve data (for example, table data (e.g., data stored in a tabular form in a communication platform datastore)) associated with the shared channel from, for example, a group-based communication repository (e.g., datastore 122). For example, in the depicted example of FIG. 4, the communication platform can determine that ACME Corporation, Beta Brands, Global Logistics and Apple Tree Inc. are associated with the #wholesale-strategy shared channel based on respective organization identifiers.

In some examples, in response to receiving the user selection input associated with the #wholesale-strategy shared channel from the user Brandon, the communication platform can update the user interface 401 to cause rendering of a shared organization set interface 409. The depicted shared organization set interface 409 can include information, descriptions, and other details associated with the #wholesale-strategy shared channel.

The shared organization set interface 409 can include a number of graphic user interface elements that are configured to convey the “external-nature” of messaging communications occurring via the #wholesale-strategy shared channel. For example, the depicted shared organization set interface 409 includes organization header 415. The organization header 415 includes colored squares (i.e., organization indicators) that represent icons or logos that visually represent member organizations. More particularly, the organization header 415 includes a first organization indicator 416A associated with ACME Corporation, a second organization indicator 416B associated with Beta Brands, a third organization indicator 416C associated with Global Logistics, and a fourth organization indicator 416D associated with Apple Tree Inc.

In some examples, rendering the organization header 415 involves rendering one or more organization indicators of organizations associated with the shared channel. For example, the communication platform may be configured to retrieve data associated with member organizations of the shared channel (for example, based on retrieved organization identifiers), and the cause rendering of associated organization indicators. In the example shown in FIG. 4, the organization indicators 416A-D are arranged in a horizontal pattern as organization header 415. In other examples discussed below, organization indicators may be arranged and/or placed in other directions and/or orientations (for example, in a vertically arranged pattern).

In the depicted example, the organization header 415 is situated in an upper position of the shared organization set interface 409 while a messaging pane 413 of the user interface 401 is more centrally positioned. The messaging pane 413 can include posted (e.g., published) messages (e.g., messaging communications). In some examples, the messaging pane 413 can include notifications of recent actions and important events associated with the shared channel. The messaging pane 413 can also document changes to channel membership, such as when an organization joins or leaves a channel, when an organization is invited to join a channel, and/or the like, details of which are described herein.

In some examples, the organization header 415 can be superimposed on top of the messaging pane 413. For example, the organization header 415 can be laid over the messaging pane 413 or a portion thereof, such that the messaging pane 413 can be updated (for example, to include rendering of new messaging communications) without affecting the position of the organization header 415. Additionally, or alternatively, the organization header 415 can be positioned in other positions within the shared organization set interface 409.

Continuing from the above example, when the shared organization set interface 409 is rendered for display on a user computing device associated with the user Brandon, the organization header 415 can be positioned above the messaging pane 413, such that Brandon may browse messages in the channel pane 413 and review the organization indicators 416A-D in the organization header 415 to identify organizations associated with the shared channel.

In some examples, the shared organization set interface 409 can include an organization list 421 instead of or in addition to an organization header 415. In the example shown in FIG. 4, the depicted shared organization set interface 409 includes the organization list 421. In one example, an organization list 421 can be revealed or otherwise displayed in response to a user clicking on or tapping an organization header 415. In some examples, the organization list 421 can include renderings of data and/or information associated with the organizations of the shared channel. For example, the organization list 421 can include a display of an organization name and an organization indicator associated with each organization of the shared channel. In the example as shown in FIG. 4, the organization list 421 includes an organization name and an organization indicator for ACME Corporation, an organization name and an organization indicator for Beta Brands, an organization name and an organization indicator for Global Logistics, and an organization name and an organization indicator for Apple Tree Inc.

In some examples, the organization list 421 can include part of a shared channel details interface (discussed in greater detail in connection with FIG. 6 below) rendered to a flexpane 417 of the group-based communication interface.

The organization list 421 can include organization indicators associated with each member organization and a respective organization count 419. The depicted organization count 419 indicates four organizations are associated with the #wholesale-strategy externally shared communication channel.

In some examples, a shared organization set interface 409 can include at least one of an organization indicator or a member count associated with each of the at least two organization identifiers. Additionally, or alternatively, the shared organization set interface 409 can include an organization name, a status identifier, and/or the like associated with each of the at least two organization identifiers. In some examples, the status identifier may indicate whether the organization is a host organization of the shared channel or a non-host organization of the shared channel. In some examples, the member count associated with the organization can correspond to the number of user members from the organization that are validated for accessing the shared channel.

In the example as shown in FIG. 4, the communication platform can cause a display, on the shared organization set interface 409, an organization name 423 (“ACME Corporation”), an organization indicator 425 corresponding to ACME Corporation, a status identifier 427 corresponding to ACME Corporation (“Owner”), and a member count 429 (“12 members”) of members having validated access to the #wholesale-strategy shared channel.

While the description above illustrates that a communication platform can generate and/or cause rendering of a shared organization set interface in response to receiving a user selection input, it is noted that the scope of the present disclosure is not limited to the shared organization set interface only. Additionally, or alternatively, other interfaces can be generated and/or caused to be rendered in response to the user selection input.

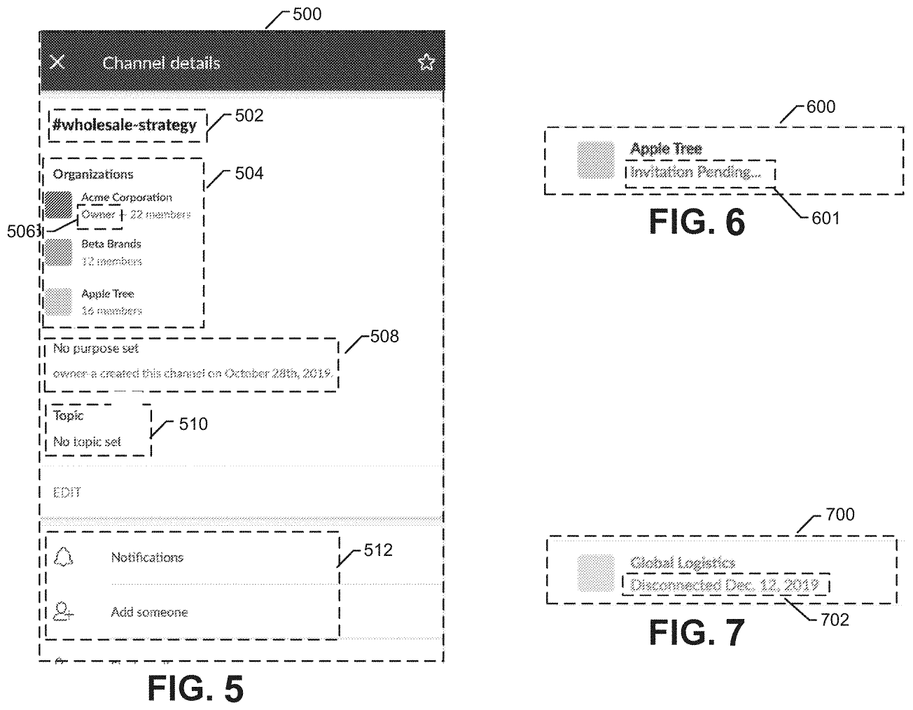

For example, in response to receiving a user selection input associated with the at least one shared channel, the communication platform can cause the display of a shared channel details interface. In some examples, the shared channel details interface can include a shared organization set interface and/or a channel title. Continuing from the above example, when Brandon clicks, taps, or otherwise selects, for example, the channel details button 431 associated with a channel header (as discussed in greater detail below), the communication platform can cause a rendering of a shared channel details interface, as will be discussed in greater detail with respect to FIG. 5.

FIG. 5 illustrates shared channel details interface 500 structured accordance with examples of the present disclosure. In some examples, the shared channel details interface 600 can be generated and/or caused to be rendered in response to a user selection input associated with an shared channel (for example, the user Brandon may select a channel title associated with a shared channel in the channel list pane as described above).

The shared channel details interface 600 can includes a shared organization set interface 604 and a channel title 602. The channel title 602 (e.g., #wholesale-strategy) corresponds to the channel title of the shared channel selected based on the user selection input. The shared organization set interface 604 is generated and/or caused to be rendered based on the retrieved organization identifiers, similar to the shared organization set interface 409 described above in connection with FIG. 4.

In some examples, the shared channel details interface 500 can include one or more portions associated with organizations of the shared channel. In the example shown in FIG. 5, the shared channel details interface 500 includes a description field 508, which may provide information associated with the shared channel (for example, date when the shared channel is created, organization that created the shared channel, and/or the like). In some examples, the shared channel details interface 500 can includes a topic field 510, which may provide information associated with topics of the shared channel. In some examples, the shared channel details interface 500 can include an operation menu 512, which may provide one or more operation options associated with the shared channel (for example, setting up notifications associated with the shared channel, adding members to the shared channel, and/or the like).

In some examples, the shared channel details interface 500 can be configured to convey various details about the shared channels. For example, the shared channel details interface 500 can include a host organization identifier 506. In some examples, the host organization identifier 506 can be positioned proximate to the organization name and/or the organization indicator of a host organization (ACME Corporation) of the shared channel.

In some examples, the shared channel details interface 500 can include one or more status identifiers that may correspond to and/or indicate the status of organizations associated with the shared channel. Example status identifiers may include, but are not limited to, a host organization identifier, a pending organization status identifier, and/or the like.

For example, FIG. 6 illustrates a portion of a shared channel details interface 600 that includes a pending organization status identifier 601. In the illustrative example, the pending organization status identifier 601 indicates that the organization (e.g., Apple Tree) has not yet accepted an invitation to join the shared channel. In some examples, the shared channel details interface 600 can provide an indication of a user and/or organization that initiates an invitation and/or an invited user and/or organization. For example, the shared channel details interface 600 can indicate that user Brandon has invited a user (e.g., Anne) from organization Apple Tree to join the #wholesale-strategy channel but this request to join has not yet been accepted or otherwise approved. The status associated with the depicted organization indicator for Apple Tree is an “invitation pending . . . ” status as illustrated in FIG. 6.

As another example, FIG. 7 illustrates a portion of a shared channel details interface 700 that includes a disconnected organization status identifier 702. The disconnected organization status identifier 702 can provide an indication that the organization (for example, Global Logistics) has been disconnected from the shared channel. For example, Brandon has disconnected the organization Global Logistics from channel #wholesale-strategy. The status of the user is indicated by the “disconnected Dec. 12, 2019” status as illustrated in FIG. 7.

While the interfaces shown in FIGS. 4-7 illustrate various example graphic interface elements, it is noted that the scope of the present disclosure is not limited to an example user interface having these graphic user interface elements. For example, some user interfaces of the present disclosure may comprise greater or fewer elements than depicted. Additionally, or alternatively, one or more elements of the user interfaces in accordance with examples of the present disclosure may be rendered in a different location and/or orientation than these as illustrated in FIGS. 4-7.

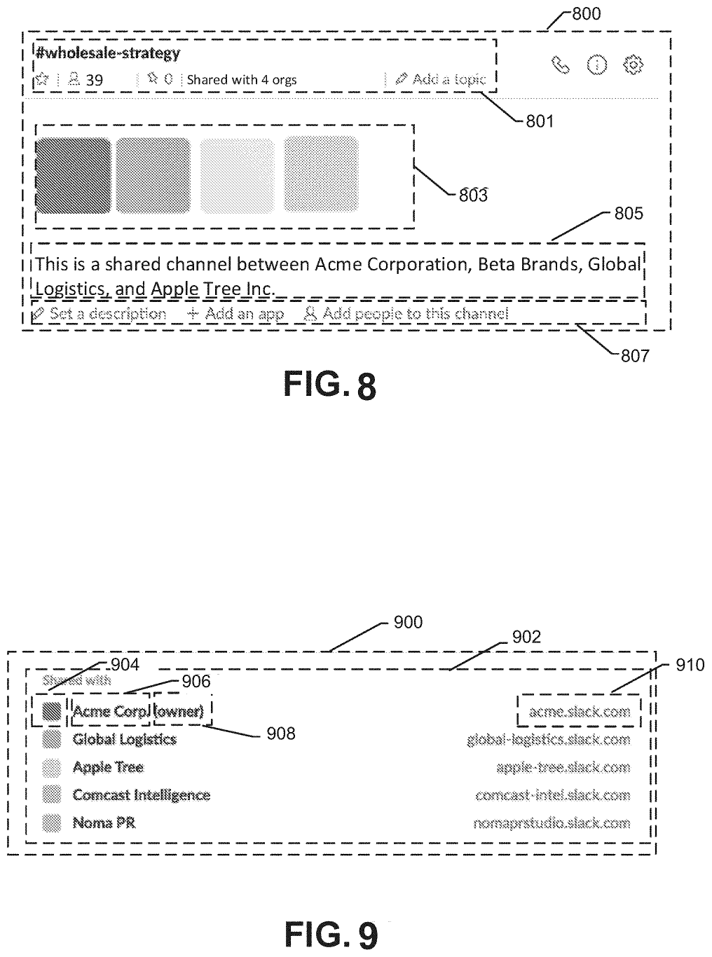

A few example variations of one or more graphic user interface elements of the user interface are illustrated in at least FIGS. 8-20.

While FIG. 4 illustrates an example organization header 415, it is noted that examples of the present disclosure can include an organization header that is different from the organization header 415 as shown in FIG. 4. For example, a user interface 800 illustrated in FIG. 8 includes an example organization header 803 with a channel banner 801. The channel banner 801 includes data/information associated with the shared channel and/or organizations of the shared channel, including, but not limited to, the channel title, the total count of members associated with the channel, the total count of organizations associated with the channel, and/or the like.

In some examples, the channel banner 801 can include a channel title (“#wholesale-strategy”), a total member count (“39”), and a total organization count (“shared with 4 orgs”). In some examples, the channel banner 801 can include a display of topics associated with the channel, and a user may add, remove, and/or edit these topics via the channel banner 801.

In the illustrative example, the user interface 800 includes description field 805. In some examples, the description field 805 can provide a text description of organizations associated with the shared channel. In the example as shown in FIG. 8, the description field 805 can include a text string that references names of organizations having validated access to the shared channel (“This is a shared channel between ACME Corporation, Beta Brands, Global Logistics, and Apple Tree Inc.).

In some examples, the user interface 800 can include an options bar 807. In some examples, the options bar 807 can provide one or more user input options that allows a user to edit the user interface 900. For example, the options bar 807 can provide input options that allows a user to change the arrangement and/or the format of the organization indicators in the organization list 803 (for example, arranging the organization indicators in a vertical direction, stacking one organization indicator on top of another organization indicator, and/or the like). Additionally, or alternatively, the options bar 807 can provide user input options that allow a user to add and/or update the organization list 803. Additionally, or alternatively, the options bar 807 can provide user input options that allow a user to add another user and/or connect an application and/or plugin to the shared channel. Additionally, or alternatively, the options bar 807 can provide other options that allow a user to customize the organization header 803.

Referring now to FIG. 9, a user interface 900 including an organization list 902 is illustrated. The depicted organization list 902 includes organization indicators 904 of organizations associated with the shared channel. Additionally, or alternatively, the organization list 902 can include an organization name 906, a status identifier 908, and an organization locator 910 associated with each organization.

In some examples, the organization locator 910 may comprise a resource locator (for example, in the form of a Uniform Resource Locator (URL)) that may provide a reference to a resource associated with the corresponding organization. In some examples, the organization locator 910 may be in other forms.

For example, when causing the rendering of the user interface 900, the communication platform can retrieve data and/or information associated with each organization of the shared channel based on, for example, an organization identifier. Subsequent to retrieving the data and/or information, the communication platform can cause a rendering of the above referenced data and/or information.

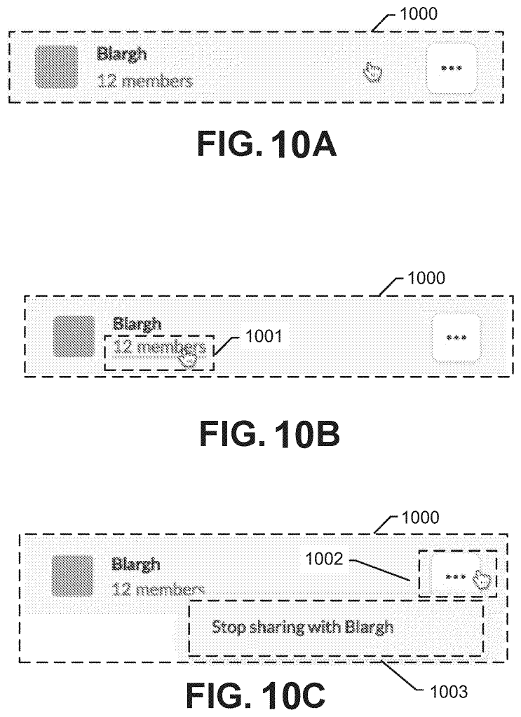

Referring now to FIGS. 10A-10C, example variations of graphic user interface elements associated with a shared organization set interface 1000 are illustrated. For example, responsive to receiving a user selection input associated with the member count 1001, the communication platform can cause a rendering of a pane that may include a list of users associated with the organization (for example, Blargh) that are members of the shared channel. In some examples, clicking on any members in the list may result in displaying a member's profile information or allowing an additional interaction to occur with the selected member, such as sending the selected member a direct message. Additionally, or alternatively, when a user selection input associated with the option button 1002 is received, the communication platform can generate an option pane 1003 that may provide one or more options associated with the organization (for example, disconnecting the organization from the shared channel).

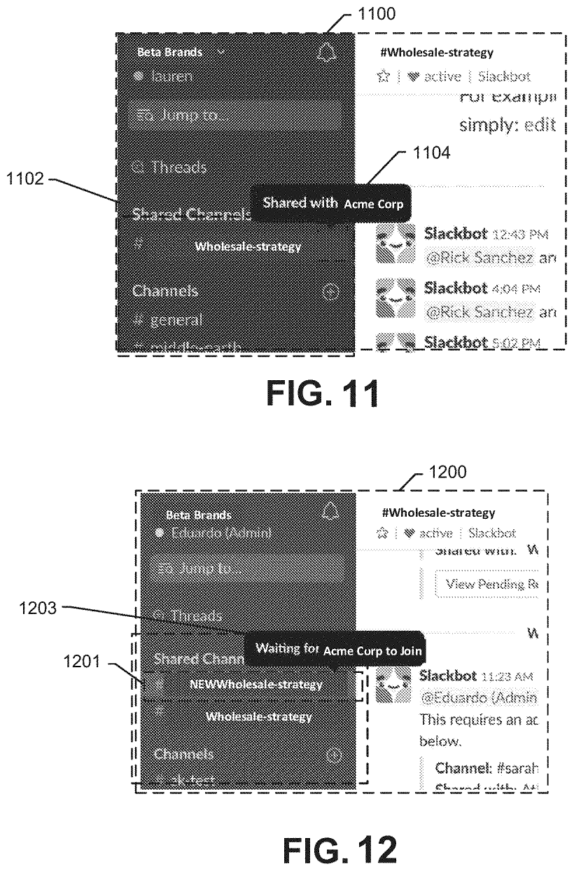

Referring now to FIGS. 11 and 12, example variations of elements associated with a channel list pane 1102 are illustrated. For example, the channel list pane 1102 of the user interface 1100 can include a channel status identifier 1104, which may indicate that the shared channel is shared with users from two or more organization(s) (for example, the channel #wholesale-strategy is shared with members from ACME Corp). The channel status identifier 1104 is provided in the form of a pop-up affordance that is accessed when a viewing user mouses-over or taps the #wholesale-strategy channel title. In other examples, another form of visual indicator or icon may be used.

The channel list pane 1201 of the user interface 1200 of FIG. 12 includes a channel status identifier 1203 that indicates that the shared channel (#NEWWholesale-strategy) is pending acceptance of one or more organizations. For example, here, ACME Corporation has not yet accepted a channel invite request.

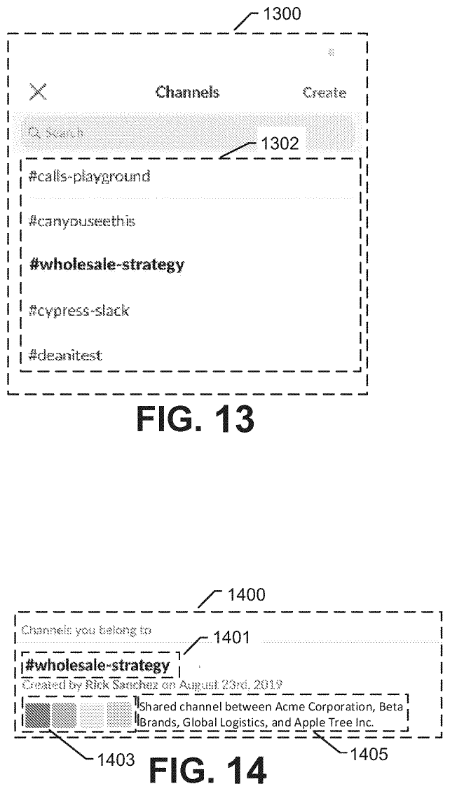

Referring now to FIG. 13, example variations of graphic user interface elements associated with a channel list pane 1302 are illustrated. In the example shown in FIG. 13, the channel list pane 1302 associated with a user interface 1300 includes channel names associated with shared channels and internal channels in the same portion or list. In the depicted example, shared channels (e.g., #wholesale-strategy) are differentiated simply by bolding while in other examples such channels may be distinguished using icons, other stylistic differences, and/or additional indicators, such as the square indicator illustrated in FIG. 2.

Referring now to FIG. 14, example variations of graphic user elements associated with a channel list pane are illustrated. In the example shown in FIG. 14, the channel list pane of a user interface 1400 provides a channel title 1401 of a shared channel, along with an organization header 1403 (or an organization list) and a description field 1405 (which may include a text string describing organizations associated with the shared channel).

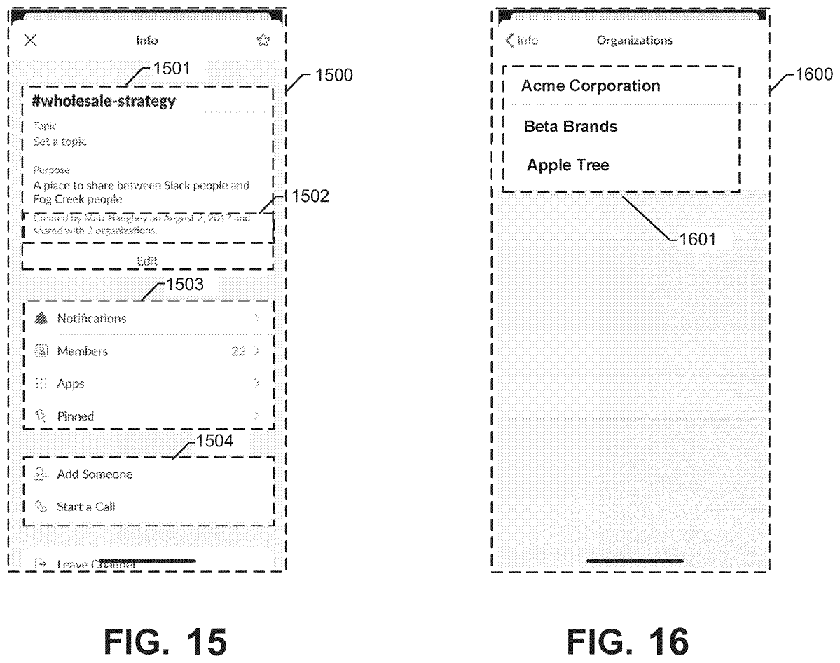

Referring now to FIGS. 15 and 16, example variations of graphic user interface elements associated with a shared channel details interface are illustrated. As described above, the shared channel details interface can be generated in response to a user selection input associated with the at least one shared channel. For example, if Brandon were to click, tap, or otherwise select, for example, the channel details button associated with a channel header of the #wholesale-strategy channel, the communication platform can be configured to cause a rendering of a shared channel details interface of the types shown. In some examples, Brandon may tap the channel name directly in the channel header to display the channel details information.

The shared channel details interface 1500 of FIG. 15 includes a shared channel summary section 1501 and option menus 1503 and 1504. The depicted shared channel summary section 1501 includes a shared organization set interface 1502 that includes a description of organizations associated with the shared channel (e.g., #wholesale-strategy). In response to receiving a user selection input associated with the shared organization set interface 1502, the communication platform can cause a rendering of a user interface 1600 as shown in FIG. 16, which includes an organization list 1601.

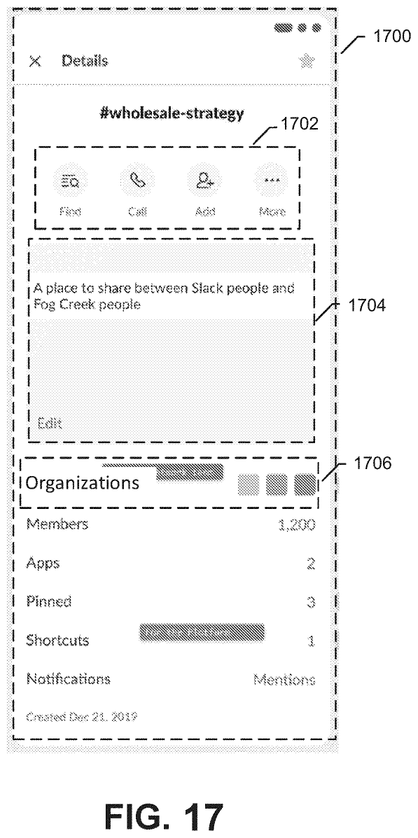

Referring now to FIG. 17, example variations of graphic user interface elements associated with a shared channel details interface 1700 are illustrated. The shared channel details interface 1700 includes options menu 1702, a description field 1704, and a shared communication channel organization set interface 1706. In some examples, the shared organization set interface 1806 can include an organization list and/or an organization header. Additionally, or alternatively, the shared channel details interface 1800 can include indications of workspaces associated with the shared channel.

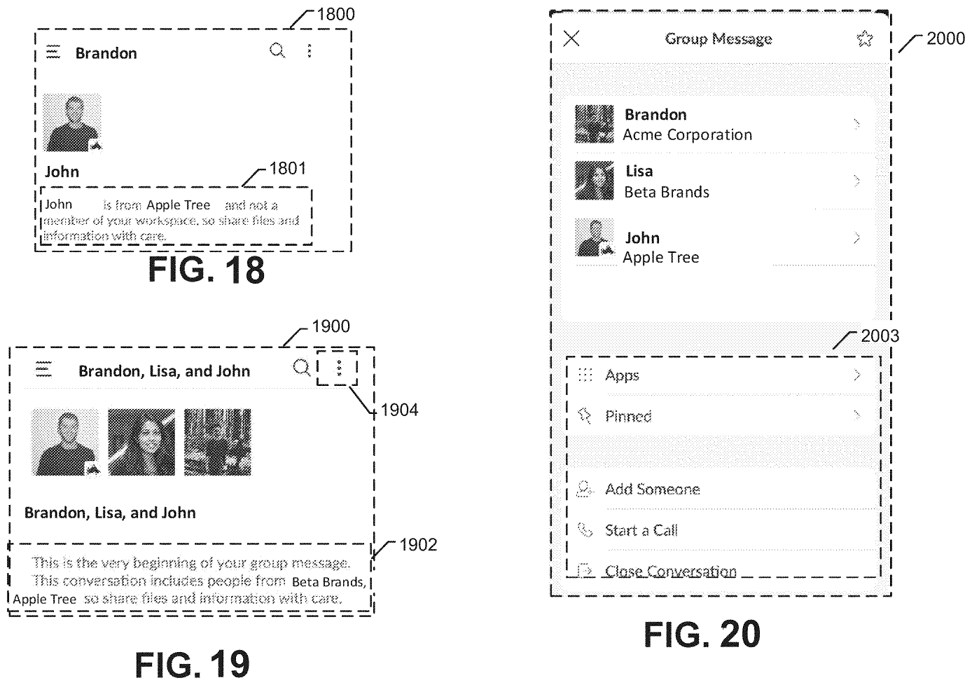

Referring now to FIGS. 18-20, example variations of elements associated with an example group-based communication interfaces are illustrated.

Referring now to FIG. 18, a user interface 1800 is illustrated. The user interface 1800 can be associated with a direct messaging between two users of a shared channel. For example, a user Brandon can send a direct message with another user of the shared channel #wholesale-strategy (for example, John). Brandon can click, tap, or otherwise select a user icon associated with John in the user interface 1800, and can confirm initiation of a direct message and/or direct messaging instance with John. In response to receiving Brandon's request, the communication platform can generate the direct messaging instance and/or the user interface 1800 as shown in FIG. 18.

In the example shown in FIG. 18, the user interface 1800 includes an organization description section 1801, which can include text and/or other forms of description that make viewing users aware of the external nature of the proposed direct messaging communications. Continuing from the above example, the organization description section 1801 includes a warning for Brandon that he is communicating with a user (John) who is associated with a different organization (Apple Tree) from his organization (ACME). In some examples, the information indicating that John is associated with a different organization is displayed in a context interface similar to that of context interface 2205 above the message box.

Referring now to FIG. 19, the user interface 1900 as shown in FIG. 19 may be associated with a multi-organization direct messaging instance between more than two users of a shared channel. In some examples, the multi-organization direct messaging instance can be associated with users who are associated with more than two organizations. For example, a user Brandon can generate a group message to other users of the shared channel #wholesale-strategy (for example, Lisa and John). Brandon can click, tap, or otherwise select user icons associated with Lisa and John in a user interface 1900, and can confirm an initiation of the group messaging instance with Lisa and John. In response to receiving Brandon's request, the communication platform can be configured to generate the direct messaging instance and/or the user interface 1900 as shown in FIG. 19.

In the example shown in FIG. 19, the user interface 1900 can include an organization description section 1902, which can include text and/or other forms of description that indicate one or more organizations associated with the users engaged in the multi-organization direct messaging (e.g., associated with the multi-organization direct messaging instance). Continuing from the above example, the organization description section 1902 includes a warning to Brandon that the other users associated with the multi-organization direct messaging instance (e.g., Lisa and John) are associated with different organizations (Beta Brands and Apple Tree) from his organization (ACME Corporation). In some examples, the information indicating that Lisa and John are associated with a different organization is displayed in a context interface similar to that of context interface 2205 above the message box.

FIG. 20 illustrates a user interface 2000 associated with a multi-organization direct messaging between more than two users of a shared channel. In some examples, the communication platform can be configured to generate the user interface 2000 responsive to user selection input via the one or more option buttons 1904 of the user interface 1900 of FIG. 19. For example, a user Brandon can click, tap, or otherwise select the one or more option buttons 1904 associated with the group messaging header of the user interface 1900. In response to receiving the selection from Brandon, the communication platform can generate the user interface 2000 shown in FIG. 20.

In some examples, the user interface 2000 can include details and other actions/information associated with multi-organization direct messaging. For example, as will be apparent to one of ordinary skill in the art in view of this disclosure, the user interface 2003 can allow users associated with a multi-organization direct message instance to send messages to one another, to access externally resources (e.g., third party apps) that are associated with or referenced with the associated shared channel, items, access messaging communications (e.g., messages) or files that are pinned to the shared channel, and the like. In some examples, the user interface 2003 can include an add a member action, a start a call option, and/or a close the conversation action.

### Shared Communication Channel Organization Context Interface

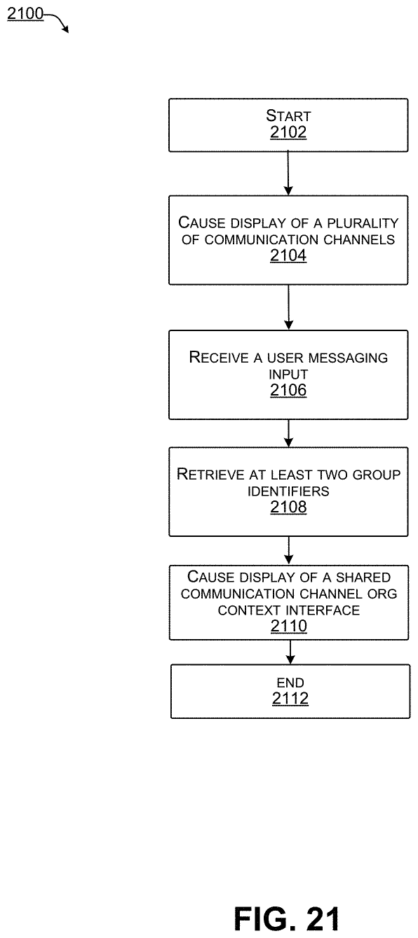

Referring now to FIG. 21, an example method 2100 is illustrated. In particular, the example method 2100 illustrates example operations for updating a user interface and providing a shared channel organization context interface. A shared channel organization context interface can include an interface element associated with a communication platform (e.g., user interface associated therewith) that is positioned proximate a messaging input interface associated with an shared channel and indicates to a viewing user that content shared to the shared channel will be viewable by members of other organizations. In some examples, the shared channel organization context interface includes an organization header. In some examples, the shared channel organization context interface can be a dynamic interface that is revealed to a viewing user in response to user engagement (e.g., clicks on or types in) a messaging input interface associated with a shared channel.

The example method 2100 may start at block 2102. At block 2104, a communication platform can cause display of a plurality of channels, similar to those described above in connection with at least block 304 of FIG. 3. In some examples, the channel titles associated with the plurality of channels can be displayed in a channel list pane of the user interface.

At block 2106, the communication platform can receive a user messaging input associated with the at least one shared channel. In some examples, the user messaging input can be received via an input device associated with a user computing device, such as user computing device 104. For example, the user messaging input may be generated from a mouse click, a keystroke on a keyboard, a tap on a touch screen, and/or the like. In some examples, the receiving the user messaging input can be triggered by user engagement of a messaging input interface.

At block 2108, the communication platform can retrieve at least two organization identifiers associated with the at least one shared channel. In some examples, the retrieving the at least two organization identifiers associated with the at least one shared channel can be triggered by receiving the user messaging input. For example, in response to receiving a user messaging input, communication platform can retrieve the at least two organization identifiers associated with the shared channel.

At block 2110, the communication platform can cause display to the user interface of a shared channel organization context interface based at least in part on the retrieved at least two organization identifiers. In some examples, the causing display to the group-based communication interface of the shared channel organization context interface can be triggered by receiving the user messaging input. For example, subsequent to receiving a user messaging input via the messaging input interface, the communication platform can update the group-based communication interface, and can cause a rendering of a shared channel organization context interface. In some examples, the shared channel organization context interface can be generated based on, for example, the organization identifiers retrieved by the communication platform at block 2108.

In some examples, the shared channel organization context interface can alert a user that any information he or she contributed may be seen by members of another groups and/or organizations. For example, the shared channel organization context interface can include a message indicating that the user is communicating with users from other organizations in this shared channel.

The example method 2100 may end at block 2112.

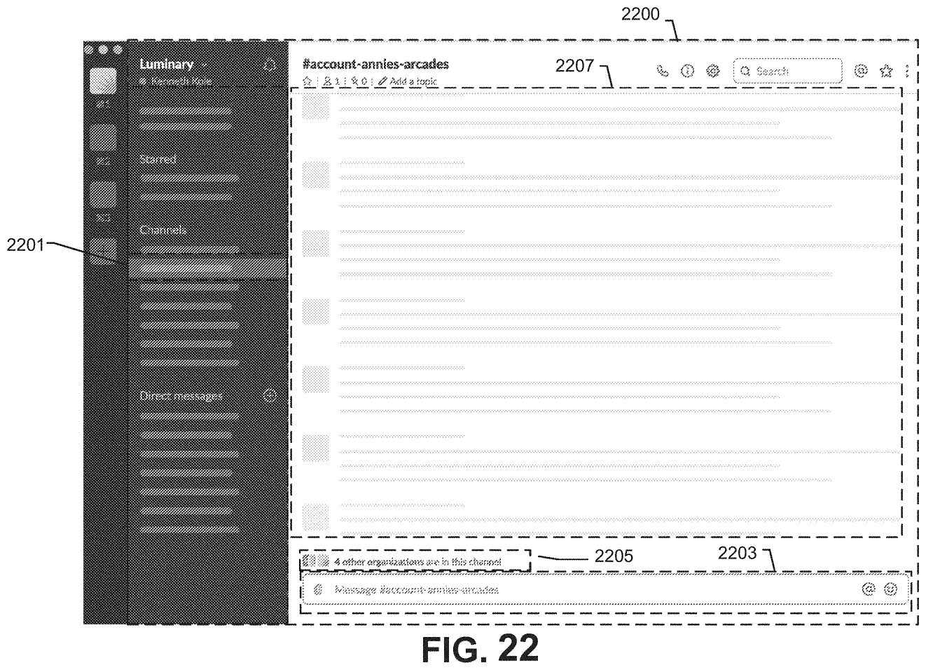

Referring now to FIG. 22, a user interface 2200 is provided. In particular, the user interface 2200 can be rendered on a display of a user computing device, such as user computing device 104.

As shown in FIG. 22, the user interface 2200 includes a channel list pane 2201. In some examples, the channel list pane 2201 can be positioned on the leftmost side of the user interface 2200, thereby allowing a user to intuitively navigate various group-based communication channels associated with the user interface 2200. In some examples, the channel list pane 2201 may be positioned at other locations of the user interface 2200, without deviating from the scope of the present disclosure.

In some examples, the channel list pane 2201 can include a plurality of channels, similar to those described above in connection with at least block 304 of FIG. 3. In some examples, the plurality of channels can include at least one shared channel.

In the example shown in FIG. 22, the user interface 2200 includes messaging input interface 2203. The messaging input interface 2203 includes an input field, such as input mechanism 214, that allows a user to add messages (e.g., text, pictures, attachments, emojis, reactjis, and/or the like) to a group-based communication channel. In some examples, the messaging input interface 2203 can provide autocomplete function, which can automatically recognize username, channel title, and other information as a user types in input field of the messaging input interface 2203. In some examples, the autocomplete function can recognize the names of applications (for example, plug-ins, bots, external resources, and/or the like) to further interact with the group-based communication channel.

As an example, a user Kenneth can input a message (for example, a string of text) through the messaging input interface 2203 associated with a shared communication channel (e.g., “#account-annies-arcades”). The message can be generated in response to Kenneth's engagement of an input device (for example, a keyboard, a mouse, touchscreen, and/or a microphone) associated with the messaging input interface 2203.

In response to receiving Kenneth's input associated with the messaging input interface 2203, the communication platform can determine a channel identifier associated with the shared communication channel “#account-annies-arcades.” Based on the channel identifier, the communication platform can retrieve data (for example, table data as defined above) associated with the shared communication channel #account-annies-arcades from, for example, a group-based communication repository (e.g., a datastore, such as datastore 122).

Based on the retrieved data, the communication platform can be configured to determine two or more organization identifiers associated with the shared channel #account-annies-arcades. As described above, each organization identifier may comprise data that uniquely identifies an organization associated with the communication platform. For example, the communication platform can determine that Luminary, ACME Corporation, Beta Brands, and Global Logistics are associated with the shared communication channel #account-annies-arcades.

The communication platform may cause an alert to be presented to the user via the shared channel organization context interface 2205, indicating that information contributed via the shared channel may be seen by members of another groups and/or organizations. For example, the communication platform may generate and cause a presentation, via the shared channel organization context interface 2205, of a message indicating that the user is communicating with users from other organizations. In the example shown in FIG. 22, the shared channel organization context interface 2205 indicates that the user is communicating with other organizations (a total of four organizations) in the shared channel.

In some examples, the shared channel organization context interface 2205 can be positioned proximate the messaging input interface. In the example shown in FIG. 22, the shared channel organization context interface 2205 is positioned proximate and above the messaging input interface 2203. In some examples, the shared channel organization context interface 2205 can be positioned proximate and below the messaging input interface 2203.

After input is received via the messaging input interface 2203, the communication platform can cause the rendering of the input (e.g., message) via the channel messaging pane 2207.

In some examples, the channel messaging pane 2207 may comprise renderings of data and/or information associated with the externally shared communication channel. For example, the channel messaging pane 2207 may display text (for example, user input received via messaging input interface 2203), images, data, and/or the like that are associated with the communication channel. For example, the data may include changes to membership, such as when an organization join or leave a channel, when an organization is invited to join a channel, and/or the like, details of which are described herein.

Continuing from the above example, after the user Kenneth provides input to the group-based communication channel via the messaging input interface 2203 (for example, a message that says “welcome to the channel”), the communication platform can cause a rendering of the input to be displayed on the channel messaging pane 2207 (for example, rendering of the message “welcome to the channel”).

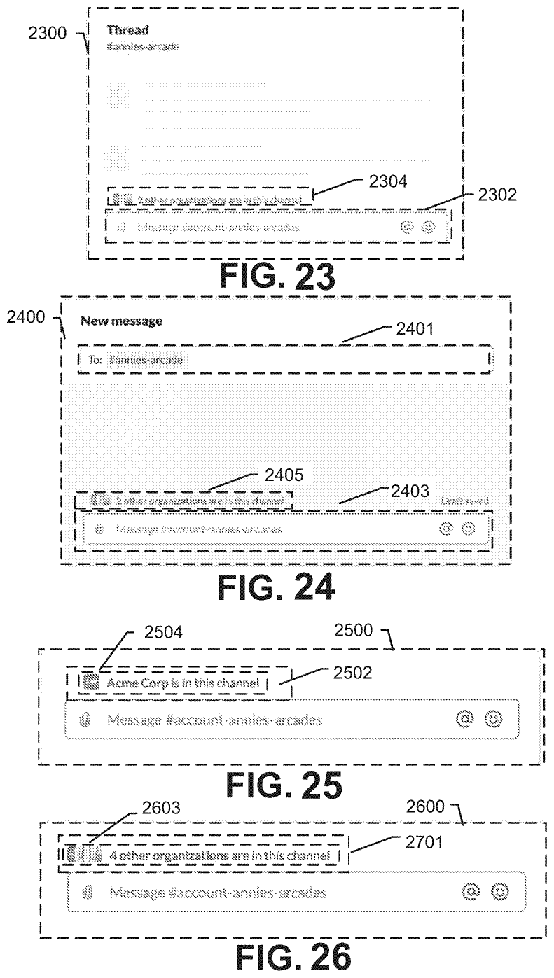

FIG. 23 and FIG. 24 also show example user engagement of example messaging input interfaces. FIG. 23 illustrates user engagement with an example messaging input interface 2302 of a thread input interface 2300 of a user interface. In this example, a user Brandon from ACME Cooperation drafts a message as part of a thread involving Kenneth with the shared channel #annies-arcade. Brandon selects the channel title #annies-arcade in a user interface. In some examples, the communication channel can generate the thread input interface 2300 including the example messaging input interface 2302 based on the selection of the channel title in the user interface. Responsive to receiving input via the messaging input interface 2302, the communication platform can cause the shared channel organization context interface 2304 to be rendered for display on a user computing device, such as user computing device 104.

In the example shown in FIG. 23, the shared channel organization context interface 2304 can provide a warning message that the message will be shared with members of other organizations associated with the shared channel (e.g., #annies-arcade). In other examples, the communication platform can cause a presentation of a separate warning message (not shown), such as in the form of a pop-up alert or modal that emphasizes the external nature of the proposed communication.

FIG. 24 illustrates user engagement with an example messaging input interface 2401 and/or an example messaging input interface 2403 of a new message interface 2400 of a user interface. In this example, the messaging input interface 2401 can provide an input field (e.g., input mechanism) for a user to input a shared channel associated with the new message (for example, “#annies-arcade” as shown in in FIG. 24), and the messaging input interface 2403 may provide an input field for content of the new messaging communication.

In the depicted example, user Brandon from ACME Cooperation can draft a message to members associated with a shared channel #annies-arcade. The communication platform can be configured to generate the new message interface 2400 comprising an input interface 2401. When Brandon provides the channel title #annies-arcade via the input interface 2401, the communication platform can cause the shared channel organization context interface 2405 to be rendered for display on a user computing device, such as user computing device 104.

In the example shown in FIG. 24, the shared channel organization context interface 2405 can serve as an alert or warning message that the message will be shared with other organizations who are members of the #annies-arcade channel.

In some examples, the shared channel organization context interface can include an organization header. In a user interface 2500 illustrated in FIG. 25, the shared channel organization context interface 2502 includes an organization header 2504, which may include organization indicator(s) associated with organizations of the shared channel and/or organization name(s) associated with organizations of the shared channel, similar to the organization header described above. As described above, the shared channel organization context interface 2502 can provide an alert to a user that any information he or she contributed may be seen by members of another groups and/or organizations. As such, the user may be alerted by the organization header 2504 that he or she is communicating with users from other organizations.

In some examples, the shared channel organization context interface 2502 can include an organization indicator count. In the example user interface 2600 illustrated in FIG. 26, a shared channel organization context interface 2601 includes an organization indicator count 2603, which may include organization indicator(s) associated with organizations of the shared channel and/or an organization count number of organizations associated with the shared channel (for example, “four other organizations are in this channel” as shown in FIG. 26). As described above, the shared channel organization context interface can provide an alert to a user that any information contributed via the user interface 2600 may be seen by members of other organizations and conveniently indicate the magnitude of such disclosure by provide an organization count.

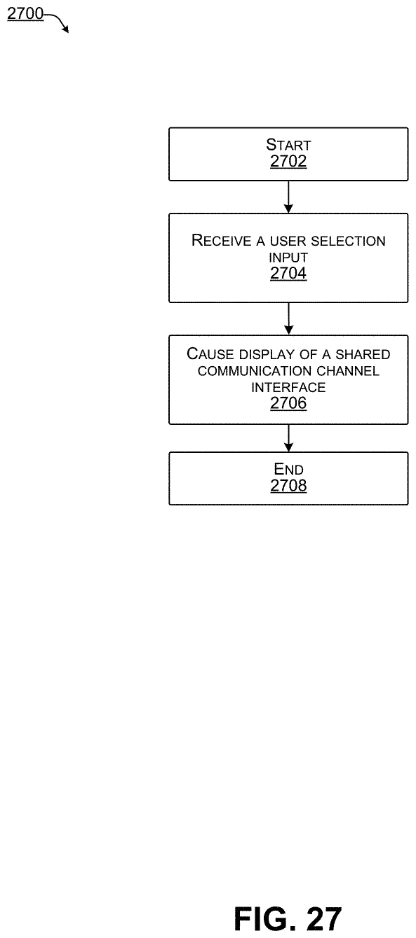

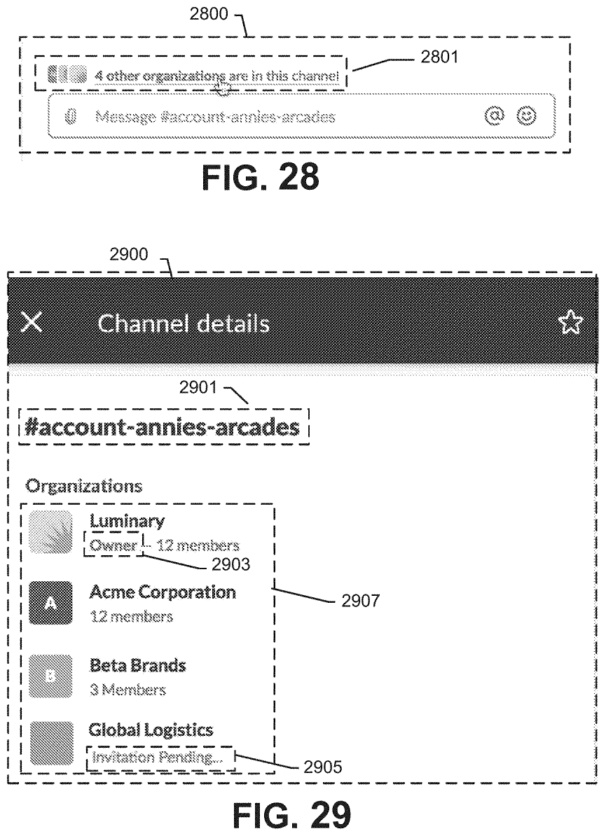

Referring now to FIG. 27, an example method 2700 is illustrated. In particular, the example method 2700 illustrates examples of providing a shared channel details interface. In describing various steps of the example method 2700, references are made to example user interfaces as shown in FIGS. 28 and 29. It is noted that the scope of the present disclosure is not limited to these example user interfaces shown in FIGS. 28 and 29.

The example method 2700 may start at block 2702. At block 2704, a communication platform can receive a user selection input (e.g., indication of selection) associated with the shared channel organization context interface.

For example, FIG. 28 illustrates a user interface 2800 that includes a shared channel organization context interface 2801. As show in FIG. 28, a user selection input associated with the shared channel organization context interface 2801 can be received based on user input via an input/output device, such as by clicking on the shared channel organization context interface 2801.

Referring back to FIG. 27, at block 2706, the communication platform can cause display of a shared channel details interface, similar to those described above.

In some examples, the shared channel details interface can include a shared channel organization set interface and a channel title. For example, FIG. 29 illustrates a shared channel details interface 2900 that can be generated in response to the user selection input described above in connection with FIG. 28. In the example shown in FIG. 29, the shared channel details interface 2900 can include a shared channel organization set interface 2907 and a channel title 2901.

In some examples, the shared channel organization set interface 2907 can include an organization list that comprises organization indicators associated with the externally shared communication channel. For example, the shared channel may be associated with four organizations: Luminary, ACME Corporation, Beta Brands, and Global Logistics. In this example, the organization header of the shared channel organization set interface 2907 includes an organization indicator for Luminary, an organization indicator for ACME Corporation, an organization indicator for Beta Brands, and an organization indicator for Global Logistics.

In some examples, the shared channel details interface 2900 can include a host organization identifier. In the example shown in FIG. 29, the shared channel details interface 2900 includes a host organization identifier 2903, which may indicate that the organization Luminary is the host of the shared channel.

In some examples, the shared channel details interface 2900 can include a pending organization status identifier 2905. The pending organization status identifier 2905 can indicate that an invitation to the organization Global Logistics to join the shared channel is still pending acceptance from the organization Global Logistics.

Referring back to FIG. 27, the method 2700 may end at block 2708.

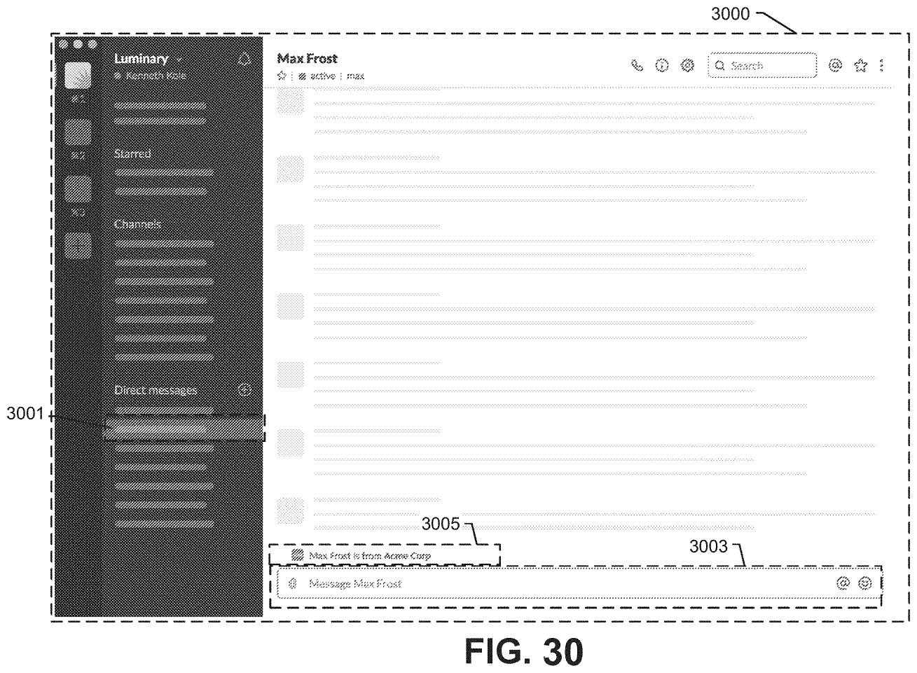

While the interfaces shown in FIGS. 22-29 illustrate various example elements, it is noted that the scope of the present disclosure is not limited to user interfaces having these elements. For example, some user interfaces of the present disclosure may include greater or fewer elements than those presented in the illustrative examples of FIGS. 22-29. Additionally, or alternatively, one or more elements of some user can be presented in different locations and/or different orientations than the elements illustrated in FIGS. 22-29. Example variations of one or more elements of the example group-based communication interface are illustrated in at least FIGS. 30-41.

Referring now to FIG. 30, example variations of elements associated with shared communication channel organization context interface 3005 are illustrated. In particular, the user interface 3000 of FIG. 30 may comprise a direct messaging interface (for example, based on a user selection input of a direct messaging pane 3001). In some examples, the communication platform can generate a shared communication channel organization context interface 3005 in response to user engagement with the messaging input interface 3003, similar to those described above.

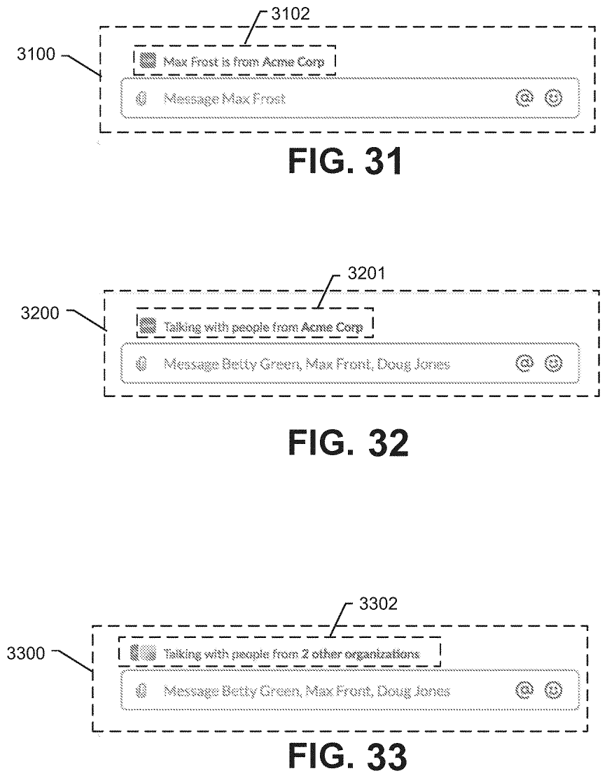

Referring now to FIGS. 31-33, example variations of elements associated with shared communication channel organization context interface are illustrated.

In particular, FIG. 31 illustrates a shared channel organization context interface 3102 associated with a direct messaging interface 3100. In the depicted example, a user Brandon from ACME Cooperation can compose and send a message to another user Max Frost associated with the shared channel #wholesale-strategy. In some examples, Brandon can initiate the direct message by selecting the user profile of Max Frost in a user interface associated with the shared channel. In some examples, responsive to receiving an indication of selection of the user profile, the communication platform can be configured to generate the direct messaging interface 3100. In some examples, the direct messaging interface 3100 can include the shared channel organization context interface 3102 to be rendered for display on a client device. In the example shown in FIG. 31, the shared channel organization context interface 3102 provides an indication that the other user (e.g., Max Frost) is associated with ACME Corporation so that Brandon might be comfortable that his message is staying within his organization. Alternatively, for example where Brandon is attempting to message another user from a different organization (e.g., Anne from Apple Tree), the shared channel organization context interface 3102 can be configured to indicate that the other user, Anne, is associated with the different organization (e.g., Apple Tree).

FIG. 32 illustrates a shared organization context interface 3201 associated with a multi-organization direct messaging interface 3200 where all other users associated with the multi-organization direct messaging instance are associated with the same organization. For example, a user Anne from Apple Tree can compose and send a message to ACME Corporation users Betty Green, Max Front, and Doug Jones, who are each associated with the shared channel #wholesale-strategy. Anne may select the user profiles of Betty Green, Max Front, and Doug Jones in a user interface associated with the shared communication channel or selected a previously created group direct message identifier that is associated with the group or a group-related conversation.

In some examples, the multi-organization direct messaging interface 3200 can provide a warning message in the form of a shared channel organization context interface 3201 indicating that Anne is about to message outside of her organization with users from ACME Corporation.

FIG. 33 illustrates a shared channel organization context interface 3302 associated with a multi-organization direct messaging interface 3300, where other users associated with the multi-organization direct messaging interface are associated with different organizations. For example, a user Anne from Apple Tree can compose and send a message to ACME Corporation users Betty Green, Max Front, and Luminary user Doug Jones, who are each associated with the shared channel #wholesale-strategy. Anne may select the user profiles of Betty Green, Max Front, and Doug Jones in a user interface associated with the shared channel or may select a previously created group direct message identifier that is associated with the group or a group-related conversation.

In some examples, the communication can be configured to generate the multi-organization direct messaging interface 3300 and to cause the multi-organization direct messaging interface 3300 to be rendered on a user computing device. The multi-organization direct messaging interface 3300 can include a shared channel organization context interface 3302 that is configured to provide a warning message to Anne that the direct messaging instance is associated with users from different organizations.

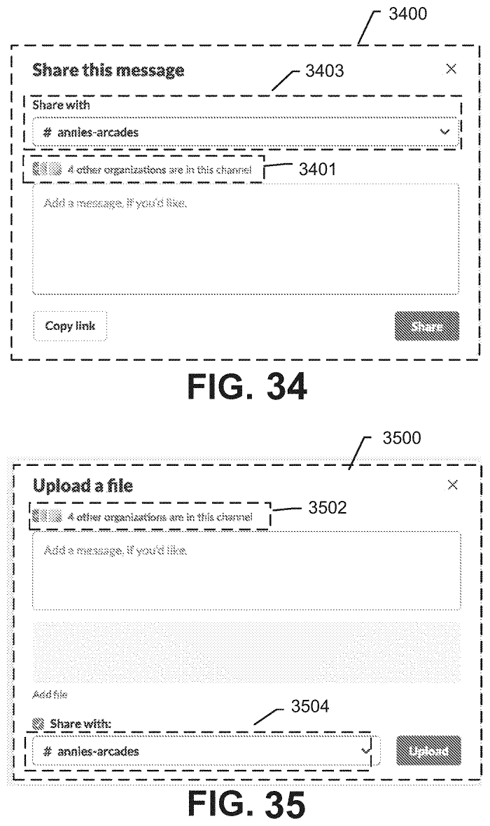

Referring now to FIGS. 34 and 35, example variations of elements associated with shared channel organization context interface are illustrated.

In particular, FIG. 34 illustrates a shared channel organization context interface 3501 associated with a message sharing interface 3400, which may be generated in response to user engagement with the messaging input interface 3403. For example, a user Brandon from ACME Cooperation can post a message via a shared channel #annie-arcades. Brandon can select the channel #annie-arcades from the messaging input interface 3403, and responsive to the selection, the communication platform can generate the shared channel organization context interface 3401. The shared channel organization context interface 3501 can include a warning message that the message will be shared with other organizations that are associated with the #annie-arcades channel, so as to caution Brandon in sharing data associated with the message to the #annie-arcades channel. In some examples, the shared channel organization context interface 3401 can include organization indicators associated with organizations in the #annie-arcades channel.

FIG. 35 illustrates a shared channel organization context interface 3502 associated with a file sharing interface 3500, which may be generated in response to user engagement with the messaging input interface 3504. For example, a user Brandon from ACME Cooperation can initiate a file share via the shared channel #annie-arcades, such as by selecting the channel #annie-arcades from the messaging input interface 3504. Responsive to receiving an indication of selection, the communication platform can generate the shared channel organization context interface 3502. The shared channel organization context interface 3502 can include a warning message that the file will be shared with other organizations that are associated with the #annie-arcades channel, so as to caution Brandon in sharing the file to the #annie-arcades channel. In some examples, the shared channel organization context interface 3502 can include organization indicators associated with other organizations in the #annie-arcades channel.

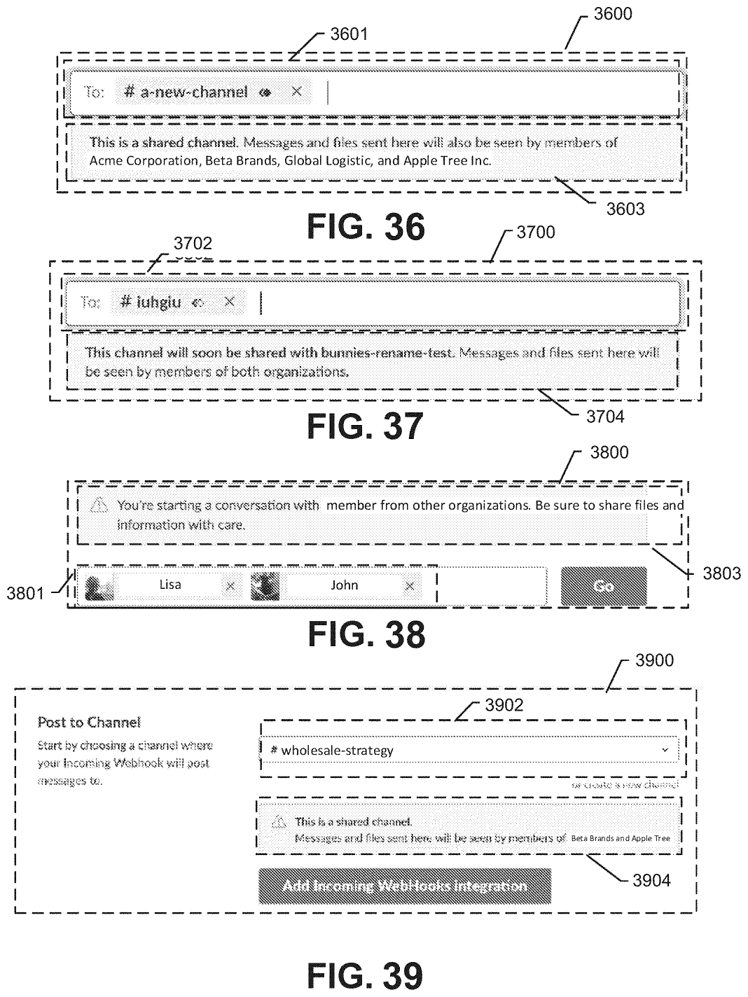

Referring now to FIGS. 36-38, example variations of elements associated with shared channel organization context interface are illustrated.

Referring now to FIG. 36, the example group-based communication interface may include a shared channel organization context interface 3603, which may be generated based on user engagement with the messaging communication input interface 3601. For example, a user may provide a user input indicating a channel title of a shared channel via the messaging communication input interface 3601. Based on determining that the indicated channel title is associated with a shared channel, the communication platform can generate the shared channel organization context interface 3603.

For example, a user Tim from Luminary can initiate sharing a message or file via a shared channel titled “#a-new-channel.” Tim may type all or part of the channel title “#a-new-channel” in the depicted messaging input interface 3601. Based on the channel title (or portion thereof), the communication platform can query a channel title database to identify the channel identifier associated with the corresponding channel included in the request (e.g., query). Responsive to determining that the requested channel is a shared channel, such as based on the channel identifier, the communication platform can cause a rendering of the shared channel organization context interface 3603, including a warning for Tim that the message or file shared via the identified channel will be shared with members from ACME Corporation, Beta Brands, Global Logistics, and Apple Tree.

Referring now to FIG. 37, the user interface 3700 can include a shared channel organization context interface 3704, which may be generated based on user engagement with a messaging communication input interface 3702. For example, a user can provide a user input indicating a channel title of a shared channel via the messaging communication input interface 3702. Based on determining that at least one organization associated with the shared channel has not yet accepted an invitation to join the shared channel, the communication platform can generate a shared channel organization context interface 3704, warning that disclosure with such pending organization may be imminent.

For example, a user Brandon from ACME Cooperation can initiate messaging via a shared channel entitled “#iuhgiu.” Brandon can type the channel #iuhgiu in the messaging input interface 3702, and the communication platform can generate the shared channel organization context interface 3704. The shared channel organization context interface 3704 can include a warning message that the message will be shared with members of a “bunnies-rename-test” workspace that involves other organizations as soon as such request to join has been accepted.

The user interface 3800 of FIG. 38 includes a shared channel organization context interface 3803, which may be generated based on user engagement with a messaging communication input interface 3801. For example, the user may provide a user input indicating one or more usernames associated with users of a shared channel via the messaging communication input interface 3801. Based on determining that at least one typed user is associated with an organization different than the user who provided the input, the communication platform can generate the shared channel organization context interface 3803.

For example, a user Brandon from ACME Cooperation can initiate a composition of a message to share with other users (for example, Lisa and John) associated with the channel #wholesale-strategy. Brandon may type the names Lisa and John in a messaging input interface 3801, and the communication platform generate the shared channel organization context interface 3803 based on a determination that Lisa and John are associated with organization(s) that are different from ACME Cooperation. The shared channel organization context interface 3803 may thus operate as a warning message that any messages or files shared by Brandon will be shared with users from other organizations.

Referring now to FIG. 39, example variations of elements associated with shared channel organization context interface are illustrated. In particular, the user interface 3900 of FIG. 39 illustrates an example user interface associated with adding a third-party app to a shared channel. Based on determining that the shared channel is associated with different organizations, the communication platform can generate the shared channel organization context interface 3904.

For example, a user Brandon from ACME Cooperation can request to install an integration for a third-party application to the channel #wholesale-strategy using a web hook. Brandon may select the channel name #wholesale-strategy in an input interface 3902, and the communication platform can generate the shared channel organization context interface 3904. For example, the communication platform can determine that the channel #wholesale-strategy is associated with organization(s) that are different from Brandon's organization (for example, involving Beta Brands and Apple Tree). The shared channel organization context interface 3904 can provide a warning to Brandon that adding the web hook integration to the indicated shared channel involves users from other organizations. In some examples, the web hook integration may refer to a set of protocol for establishing communications between applications, such as callback actions, such that these applications may exchange data/information between each other. While the above description uses web hook integration as an example, it is noted that the scope of the present disclosure is not limited to web hook integration.

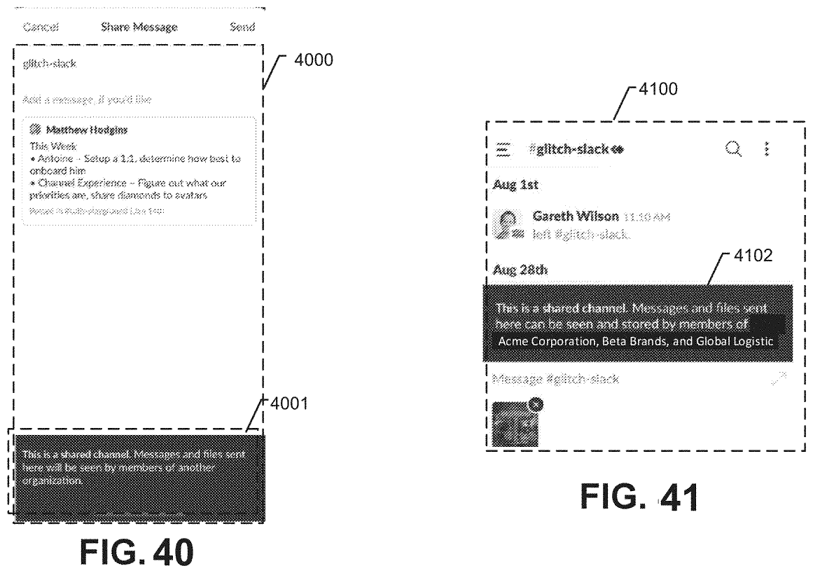

Referring now to FIGS. 40 and 41, example variations of elements associated with shared channel organization context interface are illustrated. In particular, FIGS. 40 and 41 can illustrate user interfaces of the communication platform that are associated with mobile devices.

Referring now to FIG. 40, the user interface 4000 can be associated with the sharing a message via a mobile device, and the communication platform generate a shared channel organization context interface 4001, similar to those described above.

For example, when a user Brandon initiates a message to share via the channel #glitch-slack, Brandon may select the channel title #glitch-slack form the channel list pane, similar to those described above. The communication platform can cause a rendering of the user interface 4000, which may comprise a shared communication channel organization context interface 4001 that may warn Brandon that the message shared with this channel will be seen by members of another organization.

Referring now to FIG. 41, the user interface 4100 can be associated with sharing a file to a shared channel via a mobile device, and the communication channel can generate a shared channel organization context interface 4102, similar to those described above.

For example, when a user Brandon initiates an upload of a picture to the channel #glitch-slack, Brandon may select the channel title #glitch-slack form the channel list pane, similar to those described above. The communication platform can cause a rendering of the user interface 4100, which can include a shared channel organization context interface 4102 that may warn Brandon that files shared to this channel will be seen by members of another organization or organizations (for example, ACME Corporation, Beta Brand, and Global Logistic).

### Shared Channel Invitation Interface and Authorization Interface

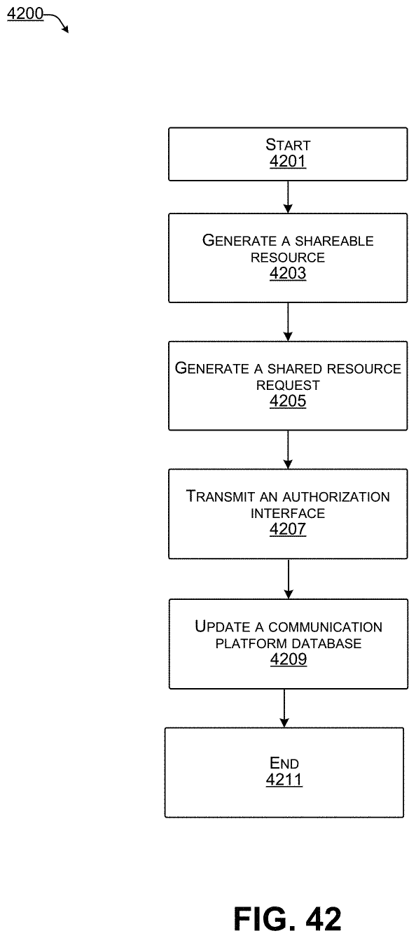

Referring now to FIG. 42, an example method 4200 is illustrated. In particular, the example method 4200 illustrates examples of generating shared channel invitation interface and authentication interface associated with a communication platform.

The example method 4200 may start at block 4201. At block 4203, the communication platform can generate a shareable resource. The shareable resource can include data that is sharable with one or more users and includes details associated with a resource sharing interface request. In some examples, the communication platform can provide the shareable resource to the sending user and/or one or more receiving users associated with the channel sharing interface request. The shareable resource can include a sending user identifier, a group-based communication resource identifier, data associated with one or more policies governing the resource (e.g., channel) associated with the resource identifier, and/or a uniform resource locator of a web page associated with the communication platform.

At block 4205, the communication platform can generate a shared resource candidate request. The shared resource candidate request can include a request or instruction that is generated by the communication platform in response to receiving a confirmation indication from a user computing device, such as user computing device 104, associated with a target user identifier of a shareable resource. The shared resource candidate request can include data similar to data included in a shareable resource, such as an identifier associated with a particular resource, a sending user identifier, one or more receiving user identifiers, and data associated with one or more policies governing the resource. Data associated with the shared resource candidate request can be rendered to an administrator user computing device associated with an administrator (e.g., administrative user) associated with the organization identifier of the shared resource candidate request. In some embodiments, a shared resource candidate request can include a shared channel candidate request. The shared channel candidate request can include a request or instruction that is generated by the communication platform in response to receiving a confirmation indication from a user computing device associated with a target user identifier of a shareable resource. The shared channel candidate request can include data similar to data included in a shareable resource, including a channel identifier, a sending user identifier, one or more receiving user identifiers, and data associated with one or more policies governing the channel associated with the channel identifier. Data associated with the shared channel candidate request can be rendered to an administrative user computing device associated with an administrator associated with the channel identifier of the shared channel candidate request.

At block 4207, the communication platform can transmit, to a first admin client device, an authorization interface renderable for display by the first admin client device. The authorization interface can include a modal, window, menu, pane, or other graphical user interface element that is configured to enable administrator user selection of an action to be taken associated with a shared resource candidate request. In various examples, the communication platform can be configured to render data associated with a shared resource candidate request to an authorization interface. In some examples, the first admin client device is associated with a respective admin user identifier associated with at least one of the first organization identifier or the second organization identifier. In some examples, the authorization interface may be associated with the shared resource candidate request.

At block 4209, the communication platform can update a communication platform database (e.g., group-based communication repository) to add a sharing approval indication associated with the resource identifier in response to receiving an authorization confirmation associated with the shared resource candidate request. For example, the communication platform can update a sharing approval repository to add a sharing approval indication associated with the resource identifier. The sharing approval indication can include an indicator, such as a flag, stored in a database by the communication platforming association with a group-based communication channel identifier or another identifier of a particular shared resource. The sharing approval indication can be stored by the communication platform in response to receiving one or more authorization confirmations from one or more admin user computing devices. The presence of a sharing approval indication in a database indicates that the channel associated with the group-based communication channel identifier and/or resource associated with the particular resource identifier is shared between two or more organizations (e.g., organization identifiers). The term “approval timestamp” refers to data representing a date on which the shared resource candidate request was approved by one or more admin users. In some examples, the sharing approval indication comprises an approval timestamp.

In some examples, the authorization confirmation comprises a first admin authorization and a second admin authorization. In some examples, the sharing approval repository comprises sharing approval indications for associated with the first organization identifier and the second organization identifier.

In various examples, the method 4200 may end at block 4211.

As an example, a user Kenneth from the organization ACME Corporation may want to invite a user Anne from the organization Apple Tree to join a shared communication channel “#wholesale-strategy.” The #wholesale-strategy channel may be shared among organizations including ACME Corporation, Apple Tree, Global Logistics, and Transit Co. Kenneth may operate a user computing device in communication with the communication platform, and the user computing device can generate an invitation or resource sharing interface request. A resource sharing interface request can include a request or instruction created by a user computing device upon user engagement with an interface element associated with creating a shared resource. The resource sharing interface request can include a sending user identifier associated with the user who initiated the request and a resource identifier associated with a resource to be shared. For example, a resource sharing interface request can be associated with a sending user identifier corresponding to Kenneth, a first organization identifier corresponding to ACME Corporation, and/or a channel identifier corresponding to the #wholesale-strategy channel.

In some examples, Kenneth may invite Anne to join a new shared channel, and the communication platform can generate a new channel identifier associated with the new shared channel.

In some examples, the resource sharing interface request can be configured to trigger the communication platform to generate a shareable resource. In such examples, based at least in part on receiving the resource sharing interface request, the communication platform can generate the shareable resource.

In various examples, non-transitory signals sent to user computing devices that contain or reference a sharable resource can be referred to as “a request to join” a shared resource associated with the sharable resource. The request to join, or a shareable resource access request can include a request or instruction that is generated by a user computing device that has received a shareable resource in response to accessing a web page associated with a uniform resource locator of the shareable resource. In some examples, the shareable resource access request can be transmitted to and received by the communication platform. In some examples, the shareable resource access request can be received in response to a user computing device accessing a hyperlink associated with the uniform resource locator.

In some examples, the communication platform can provide the shareable resource to a user computing device associated with the sending user (i.e. Kenneth) and a user computing device associated with the receiving user (i.e. Anne). In some examples, the communication sent to Anne that includes the shareable resource is referred to a request to join a group-based communication resource such as a shared channel (i.e., the #wholesale-strategy channel).

The shared resource candidate request can be generated in response to receiving a confirmation indication. The confirmation indication can include a request or instruction that is generated by a user computing device and transmitted to the communication platform in response to the user computing device receiving a shareable resource and the user associated with the user computing device subsequently approving the request. That is, the confirmation indication can be generated and sent to the communication platform responsive to a user accepting an invitation to join a shared resource (e.g., a shared channel). The confirmation indication can include data associated with a shareable resource, such as the sending user identifier, channel identifier, a receiving user identifier associated with a user who initiated the generation of the confirmation indication, and, in some embodiments, data associated with a workspace to associate with the channel identifier.

In some examples, the communication platform can provide the shareable resource to a user computing device associated with the sending user and a user computing device associated with the receiving user. The latter transmission is referred to herein as a request to join. In various examples, the communication platform can generate a shared resource candidate request in response to receiving a confirmation indication from the user computing device associated with the receiving user (i.e., in reply to the request to join). The confirmation indication is associated with the at least one receiving user identifier (associated with the receiving user) and a second organization identifier.

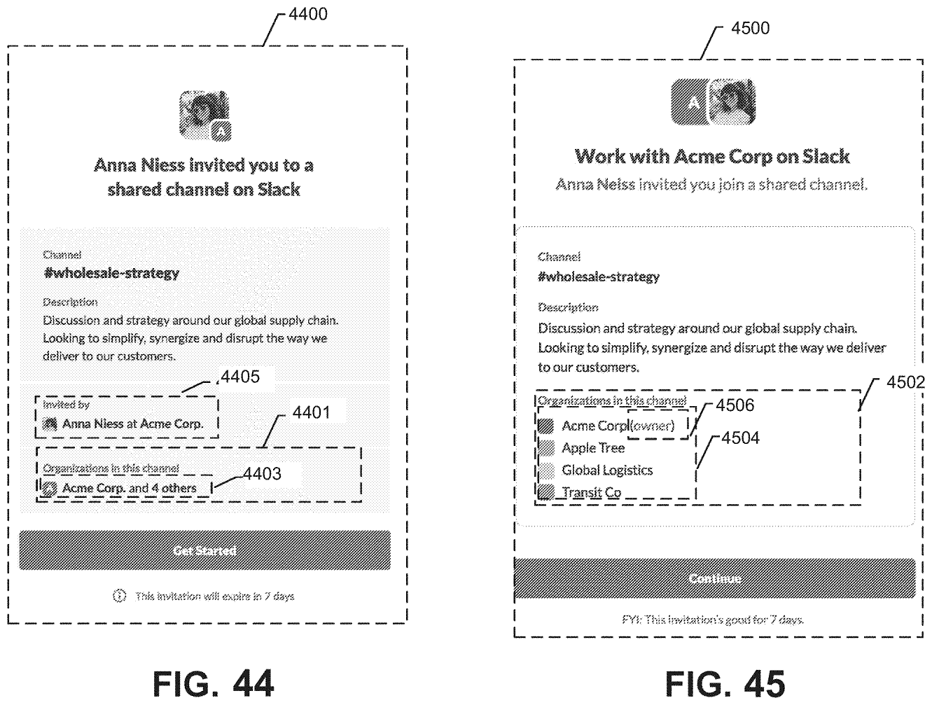

Continuing from the above example, in circumstances where Anne received a request to join the #wholesale-strategy channel via her client device, she may indicate her acceptance of the request to join (i.e., by indicating acceptance through shared channel invitation interfaces of the types depicted in FIGS. 44-48) thereby triggering the communication platform to generate a confirmation indication. In the depicted example, the confirmation indication is associated with Anne's user identifier and an organization and/or organization identifier associated with Anne (i.e., Apple Tree).

In some examples, after receiving a confirmation indication from a user computing device associated with user Anne, the communication platform can generate an authorization interface that is displayed to an administrative user computing device associated with an administrator (e.g., user with an associated administrator identifier) associated with Kenneth's organization (i.e., ACME Corporation). For example, a user Adam may be an admin user for ACME Corporation and the communication platform can transmit an authorization interface for display to Adam's user computing device (e.g., an admin user computing device).

The communication platform can be configured to transmit the authorization interface to a second admin user computing device as an additional or alternative operation. The communication platform can be configured to require an admin user from a joining organization to approve when one of its members is asked to join a shared resource. For example, admin user John of Apple Tree may be required to authorize Anne's accepted request to join the #wholesale-strategy channel. In such a case, the communication platform can be configured to transmit the authorization interface to John's client device.

Returning specifically to the example discussed above, should Adam indicate approval of Anne's accepted request to join the #wholesale-strategy channel, the communication platform can be configured to generate an authorization confirmation (e.g., request or instruction generated by an admin user computing device and transmitted to the communication platform in response to the admin user computing device receiving an indication of approval of a shared resource candidate request). As such, the authorization confirmation can include an admin authorization indicating Adam's approval on behalf of ACME Corporation. In another example where John's approval of Anne's accepted request to join the #wholesale-strategy channel is also required, the authorization confirmation may include a first admin authorization indicating Adam's approval on behalf of ACME Corporation and a second admin authorization indicating John's approval on behalf of Apple Tree. In some examples where only John's approval is required, the authorization confirmation may include only an admin authorization indicating John's approval on behalf of Apple Tree.

In various examples, updated table data associated with the resource identifier can include sharing approval indications associated with existing members and newly joined organization identifiers. Continuing with the above example where Anne has accepted a request to join the #wholesale-strategy channel and one or both of Adam and John have approved that acceptance, the communication platform configured to update the table data of the communication platform database (e.g., group-based communication repository) to include a sharing approval indication associated with an Apple Tree organization identifier.

The example method illustrated in FIG. 42 detailed a process whereby a host organization (e.g., ACME Corporation) invited a user from a non-host organization (i.e., Anne from Apple Tree) to join a shared channel. As will be apparent to one of ordinary skill in the art in view of this disclosure, this example method 4200 involved at least one admin user approval process (the approval process involving Adam) and optionally a second (the approval process involving John) to ensure that messaging communications associated with a channel are not inadvertently shared or shared in contravention from any admin user or organization specified policy.

Other sharing controls are contemplated by various examples in addition to those mentioned above. For example, in one example, a host organization (e.g., ACME Corporation) may be the only organization authorized to send requests to join in connection with its set of channels. In one example, non-host organizations (e.g., Beta Brands, Apple Tree, etc.) may be blocked from generating requests to join shared channels that they do not host (e.g., #wholesale-strategy channel). In another example, attempts by non-host organizations (e.g., Beta Brands, Apple Tree, etc.) to generate requests to join shared channels that they do not host will cause the communication platform to generate and present, on a user interface, an error indication that is sent to user computing devices (e.g., an admin user client device, user computing device associated with the requesting user) associated with any non-host organization that is attempting to generate such unauthorized requests to join. Such error indications may take the form of pop-up messages or modals. In other examples, attempts by non-host organizations (e.g., Beta Brands, Apple Tree, etc.) to generate requests to join shared channels that they do not host will cause the communication platform to generate and present, on a user interface, an alert indication that is sent to a user computing device (e.g., an admin user client device) associated with the host organization identifier (e.g., ACME Corporation). Such alert indication may trigger an admin user approval process for the host organization of the type described above.

In still other examples, the communication platform may be configured to encourage sharing of channels within members of previously authorized non-host organizations. For example, in one example, once Anne from Apple Tree has been approved for membership with the #wholesale-strategy channel, Anne may be allowed to issue additional requests to join the #wholesale-strategy channel to other users of her organization who are not yet members. In one example, any request to join issued from Anne to other Apple Tree users may not require admin approval processes of the type discussed above because an admin user of ACME Corporation (Adam) and potentially an admin user of Apple Tree (John) have already considered and authorized communication and collaboration between the two organizations within the #wholesale-strategy channel. In such examples, a request to join issued from Anne to other non-host organizations may require additional admin user approvals or be blocked (e.g., not permitted).

In another example, an admin user from a host organization can designate a whitelist organization directory for encouraging efficient sharing of a channel. In such examples, requests to join issued by client devices associated with a host organization identifier (e.g., ACME Corporation) and/or a non-host organization identifier (Apple Tree) may proceed without requiring admin approval processes of the type discussed above so long as any receiving user is associated with an organization identified on the whitelist organization directory.

In still other examples, sharing controls of the type discussed above may be further limited such that any member of a channel may be allowed to issue a request to join to non-member users without concern for host versus non-host organization identifier status. For example, Anne from Apple Tree (a non-host organization) may be able to issue a request to join the #wholesale-strategy channel to Peter of Pan's Pipefitters. In one example, such a request to join would trigger the admin approval processes discussed above but, in other examples where channel messaging communications are deemed less sensitive, such admin approval processes may not be triggered.

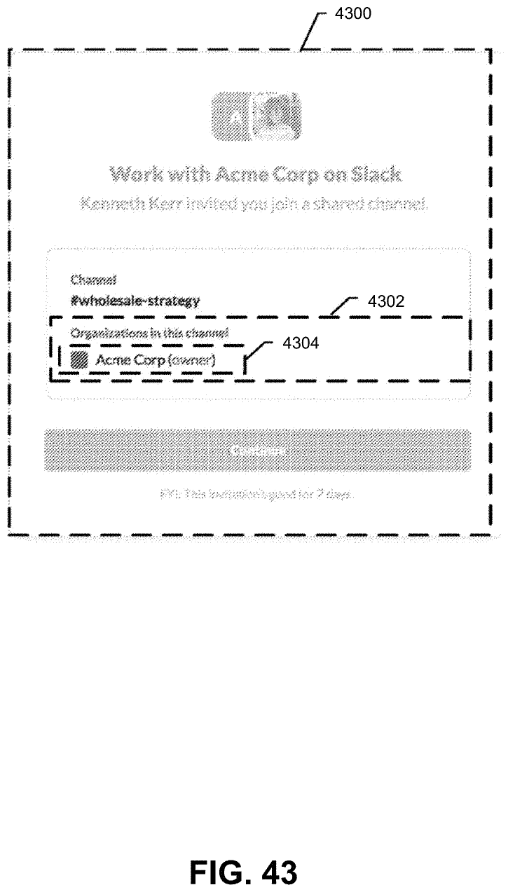

Referring now to FIGS. 43-46, example shared channel invitation interfaces 4300, 4400, 4500, and 4600 are illustrated, respectively.

In some examples, the shared channel invitation interface may comprise a shared channel organization set interface. In some examples, the shared channel organization set interface of the shared channel invitation interface may comprise an organization header and/or other form of element that indicate the organizations associated with the shared channel.

Referring now to FIG. 43, the shared channel invitation interface 4300 of FIG. 43 can include a shared channel organization set interface 4302. In some examples, the shared channel organization set interface 4302 of the shared channel invitation interface 4300 as shown in FIG. 43 can include an organization indicator section 4304, which may indicate the host organization associated with the shared channel.

For example, a user Kenneth may invite another example John to join a shared channel #wholesale-strategy. The shared channel may be associated with a host organization ACME Corporation. In this example, the communication platform can generate and cause rendering of the shared channel invitation interface 4300 on a user computing device associated with John, which may comprise an invitation to John for joining the channel #wholesale-strategy. As shown in FIG. 43, the shared channel invitation interface 4300 may comprise an organization indicator section 4304, which may indicate the host organization associated with the channel #wholesale-strategy. As such, John may be informed about the host organization of the channel #wholesale-strategy prior to making a decision on whether the join the channel.

Referring now to FIG. 44, a shared channel invitation interface 4400 can include a shared channel organization set interface 4401. The shared channel organization set interface 4401 can include an organization header 4403.

For example, a user Anne may invite another user, John, to join a shared channel #wholesale-strategy. The shared channel may be associated with a host organization ACME Corporation. In this example, the communication channel can generate and cause rendering of the shared channel invitation interface 4400 on a user computing device associated with John, which may include an invitation for John to join the channel #wholesale-strategy. As shown in FIG. 44, the shared channel invitation interface 4400 can include an invitation information section 4405, which may indicate the user who sent the invention and the organization associated with the user (for example, Anne at ACME Corporation). In some examples, the shared channel invitation interface 4400 can include an organization header 4403, which may indicate the host organization associated with the channel #wholesale-strategy and that there are four other organizations associated with the channel #wholesale-strategy. As such, John may be informed about who invited him to the channel #wholesale-strategy, as well as the host organization and other organizations of the channel #wholesale-strategy prior to making a decision on whether the join the channel.

In some examples, the shared channel organization set interface 4401 of the shared channel invitation interface 4400 can include an organization list. In some examples, the shared channel organization set interface 4401 of the shared channel invitation interface 4400 may comprise a host organization identifier.

Referring now to FIG. 45, the shared channel invitation interfaces 4500 can include a shared channel organization set interface 4502. The shared channel organization set interface 4502 can include an organization list 4504. In some examples, the shared channel organization set interface 4502 can include a host organization identifier 4506 (for example, as part of the organization list 4504).

For example, a user Anne may invite another user, John, to join a shared channel #wholesale-strategy. The shared channel may be associated with a host organization ACME Corporation. In this example, the communication platform can generate and cause rendering of the shared channel invitation interface 4500 on a user computing device associated with the user John, which may comprise an invitation for John to join the channel #wholesale-strategy. As shown in FIG. 45, the shared channel invitation interface 4500 may comprise a shared communication channel organization set interface 4502, which may indicate the host organization associated with the channel #wholesale-strategy (ACME Corporation) and that there are three other non-host organizations associated with the channel #wholesale-strategy Apple Tree, Global Logistics, and Transit Co). As such, John may be informed about the host organization and other organizations of the channel #wholesale-strategy prior to making a decision on whether the join the channel.

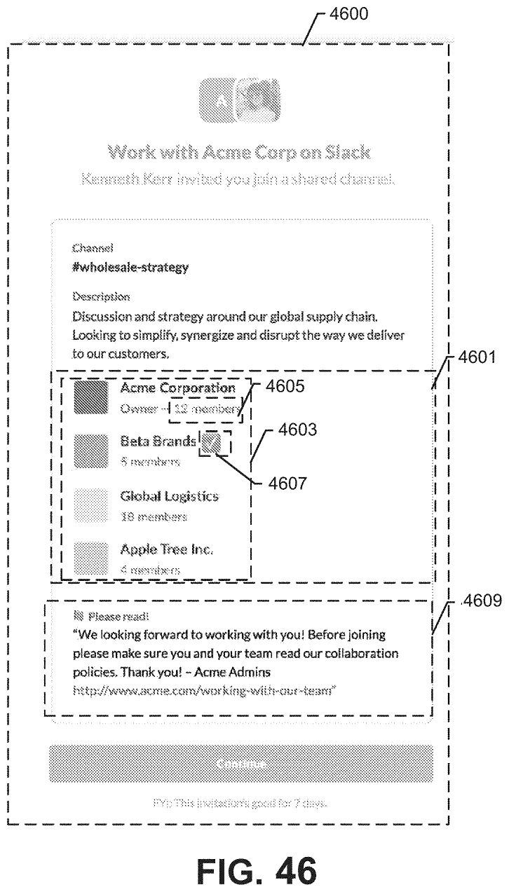

Referring now to FIG. 46, a shared channel invitation interface 4600 can include a shared channel organization set interface 4601. The shared channel organization set interface 4601 can include an organization list 4603. In some examples, the shared channel organization set interface 4601 of the shared channel invitation interface 4600 can include an organization list 4603 and member count data 4605. In some examples, the shared channel organization set interface 4601 can include a verified identifier 4607, which may indicate that the authenticity of the organization has been verified by the communication platform. Additionally, or alternatively, the shared channel organization set interface 4601 can include a policies section 4609, which may, for example, display security policies associated with the shared channel.

For example, a user Kenneth may invite another user, John, to join the shared channel #wholesale-strategy. The shared channel may be associated with a host organization ACME Corporation. In this example, the communication platform can generate and cause rendering of the shared channel invitation interface 4600 on a client device associated with the user John, which may comprise an invitation for John to join the channel #wholesale-strategy. As shown in FIG. 46, the shared channel invitation interface 4600 can include the shared channel organization set interface 4601, which may indicate the host organization associated with the channel #wholesale-strategy (ACME Corporation) and that there are three other non-host organizations associated with the channel #wholesale-strategy Apple Tree, Global Logistics, and Transit Co). In addition, the organization Beta Brands may be associated with a verified identifier, which may indicate that the authenticity of Beta Brands has been verified by the communication platform. The shared channel organization set interface 4601 can include a policies section 4609, which may, for example, display security policies associated with the #wholesale-strategy channel. As such, John may be informed about the host organization and other organizations of the channel #wholesale-strategy, as well as policies associated with the channel, prior to making a decision on whether the join the channel.

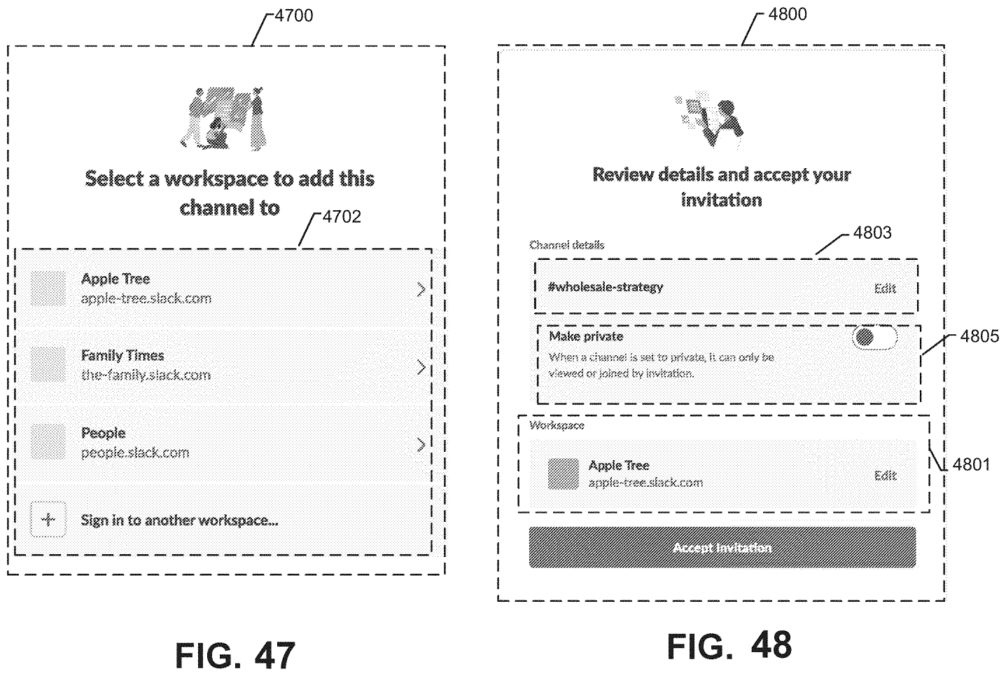

Referring now to FIGS. 47-50, example shared channel invitation interfaces 4700, 4800, 4900, and 5000 are illustrated, respectively.

Referring now to FIG. 47, a shared channel invitation interface 4700 is illustrated. For example, in response to receiving a user John's acceptance of joining a shared channel, the communication platform can cause the rendering of the shared channel invitation interface 4700 on a client device associated with John.

In some examples, the shared channel invitation interface 4700 can include a workspace designation interface that allows a receiving user (e.g., John) to designate a workspace from the shared channel. Continuing from the above example, John can select a workspace to add the channel #wholesale-strategy to.

Referring now to FIG. 48, the shared channel invitation interface 4800 of FIG. 48 can include a workspace designation interface 4801 that allows a receiving user to designate a workspace from the shared channel.

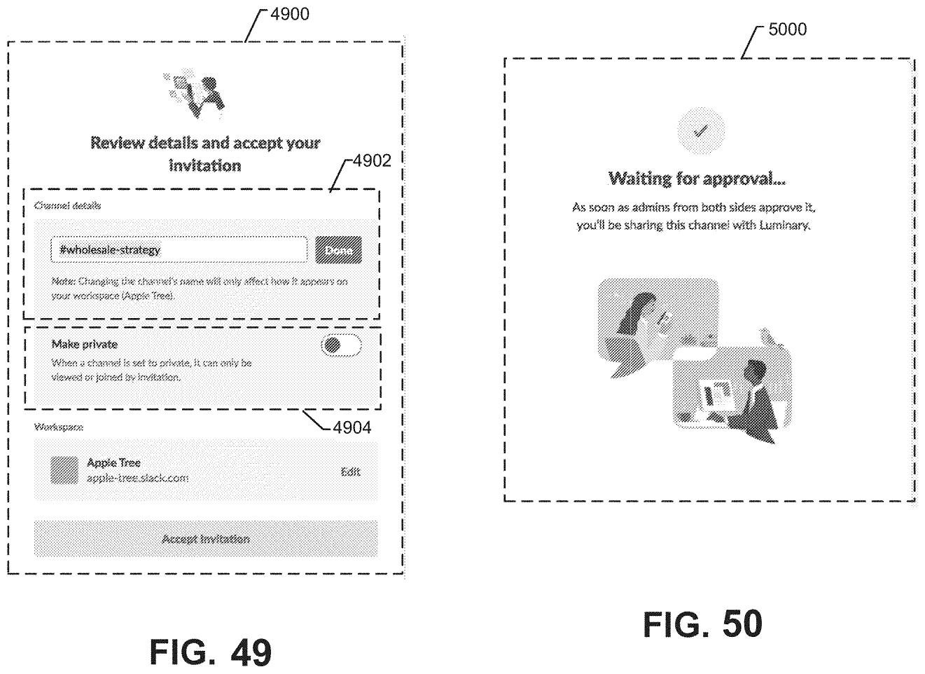

In some examples, the shared channel invitation interface 4800 can include a channel label editing interface 4803. When the user selects the “edit” option on the channel label editing interface 4803, the communication platform can update the channel label editing interface 4803 to allow a user to edit the channel label, as shown in the channel label editing interface 4902 of the shared channel invitation interface 4900 in FIG. 49.

In some examples, the shared channel invitation interface 4800 can include a channel privacy designation interface 4805. The user may toggle or edit the channel privacy designation interface 4805 in the communication platform to update the privacy designation associated with the channel, as shown in the channel privacy designation interface 4904 of the shared channel invitation interface 4900 in FIG. 49.

Continuing from the above example, after the user John accepts the invitation to join the #wholesale-strategy channel, the communication platform can cause rendering of the shared channel invitation interface 4800 on a client device associated with John. The shared channel invitation interface 4800 can include a channel label editing interface 4803, which may indicate a current channel label for the #wholesale-strategy channel. The shared channel invitation interface 4800 can include a channel privacy designation interface 4805, which may indicate that the current privacy setting of the #wholesale-strategy channel is private. The shared channel invitation interface 4800 may comprise a workspace designation interface 4801, which may indicate a current workspace for the #wholesale-strategy.

The channel label editing interface 4803, the channel privacy designation interface 4805, and the workspace designation interface 4801 can enable the user to edit details associated with the channel. For example, after the user John selects “edit” on the channel label editing interface 4803, the communication platform can cause rendering of the shared channel invitation interface 4900 as shown in FIG. 49. John may, for example, edit the channel label via the channel label editing interface 4902.

In some examples, subsequent to the receiving a user input corresponding to a confirmation indication via the shared channel invitation interface on the client device, the communication platform can generate a shared resource candidate request. As described above, the shared channel candidate request can include data similar to data included in a shareable resource, including an identifier associated with a particular group-based communication resource, a sending user identifier, one or more receiving user identifiers, and data associated with one or more policies governing the group-based communication resource associated with the particular resource identifier.

In some examples, subsequent to generating the shared resource candidate request, the communication platform can cause the client device to update to a user interface to indicate that the request to join the shared channel is pending approval from an admin user (similar to the user interface 5000 illustrated in FIG. 50).

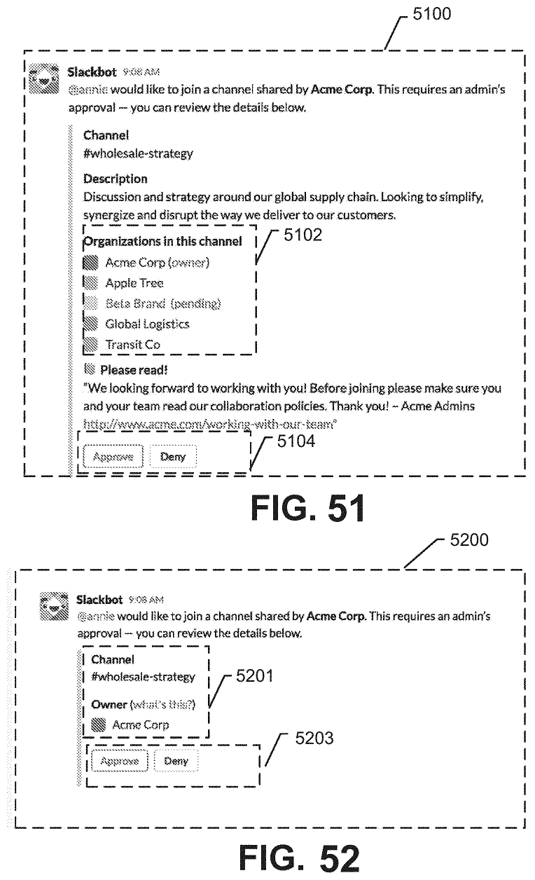

FIGS. 51-55, illustrate example authorization interfaces.

Referring now to FIG. 51, the authorization interface 5100 can include a shared channel organization set interface 5102 and option buttons 5104 that allow an admin user associated with a shared channel to approve (i.e. authorization confirmation) or deny a shared resource candidate request.

For example, after a user Anne accepts the invention to join the shared channel #wholesale-strategy, the communication platform can cause the authorization interface 5100 to be rendered for display on a user computing device associated with an admin user of the #wholesale-strategy (for example, Brandon). As shown in FIG. 51, the authorization interface 5100 can include the shared channel organization set interface 5102 that lists organizations associated with the #wholesale-strategy channel. As such, Brandon may review the organizations associated with the #wholesale-strategy channel prior to making a decision on whether to approve Anne joining the #wholesale-strategy channel, which may reduce the risk of inadvertently approving a request that may, for example, create a conflict of interest.

Referring now to FIG. 52, the authorization interface 5200 illustrated in FIG. 52 can include a shared channel organization set interface 5201 and option buttons 5203 that enable the admin user to approve (i.e. authorization confirmation) or deny a shared resource candidate request.

For example, after a user Anne accepts the invention to join the shared channel #wholesale-strategy, the communication platform can cause the authorization interface 5200 to be rendered for display on a user computing device associated with an admin user of the #wholesale-strategy (for example, Brandon). As shown in FIG. 52, the authorization interface 5200 can include the shared channel organization set interface 5201 that indicates a host organization associated with the #wholesale-strategy channel. As such, Brandon may review the host organization information associated with the #wholesale-strategy channel prior to making a decision on whether to approve Anne joining the #wholesale-strategy, which may reduce the risk of inadvertently approving a request that may, for example, create a conflict of interest.

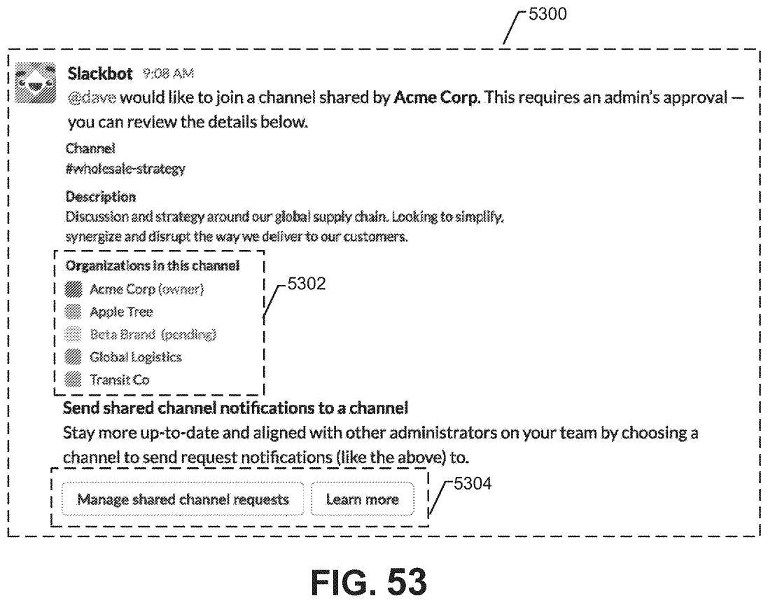

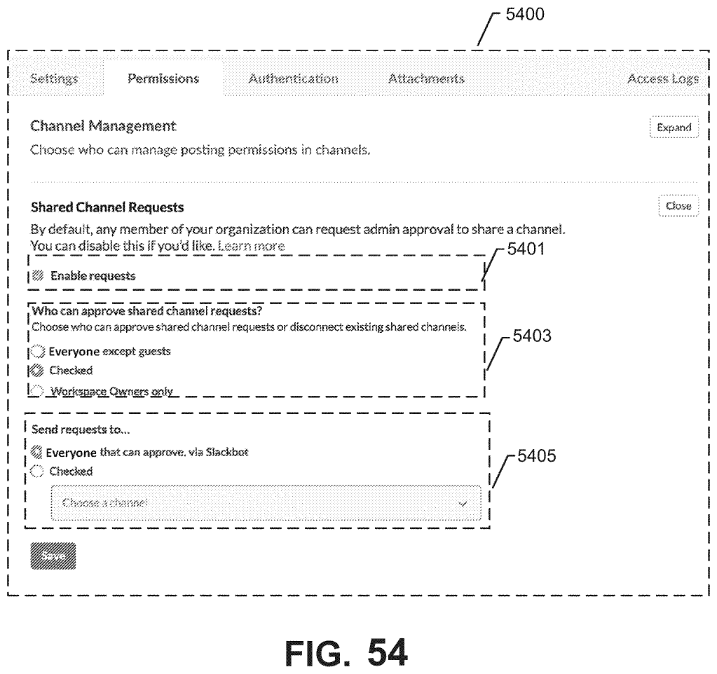

Referring now to FIG. 53, the authorization interface 5300 of FIG. 53 can include a shared channel organization set interface 5302 and option buttons 5304 that enable an admin user to manage shared channel requests. Once a user selects a “manage shared channel request” button of the option buttons 5304, the communication platform can cause a rendering of a shared channel request management interface, such as the shared channel request management interface 5400 illustrated in FIG. 54.

For example, after a user Anne accepts the invention to join the shared channel #wholesale-strategy, the communication platform can cause the authorization interface 5300 to be rendered for display on a client device associated with an admin user of the #wholesale-strategy (for example, Tina). As shown in FIG. 53, the authorization interface 5300 can include a shared channel organization set interface 5302 that lists organizations associated with the #wholesale-strategy channel. The authorization interface 5300 can include option buttons 5304 that allow Tina to choose to manage shared channel requests. After Tina clicks, taps, or otherwise selects the “manage shared channel request” button, the communication platform can cause a rendering of the shared channel request management interface 5400 illustrated in FIG. 54.

The shared channel request management interface 5400 can include option settings 5401, 5403, and/or 5405, which can enable an admin user to choose whether to enable a request, users authorized to approve the request, and where to forward the request to.

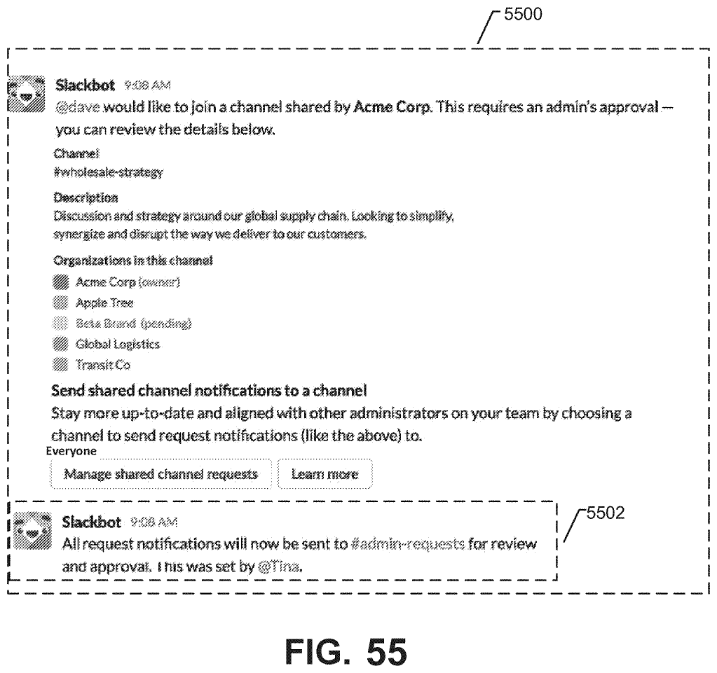

Continuing from the above example, Tina may choose that requests are enabled in the option setting 5401, that selected members can approve shared channel requests in the option setting 5403, and that requests can be sent to everyone that can approve in the option setting 5405. After Tina click, taps, or otherwise selects the save button to confirm the option settings 5401, 5403, and 5405, the communication platform can store the option settings in a datastore and generate the authorization interface 5500 as shown in FIG. 55.

As shown in FIG. 55, the authorization interface 5500 can provide an indication associated with the shared channel request management (for example, the message 5502). In various examples, the message 5502 can include data associated with option settings input via the shared channel request management interface 5400 of FIG. 54. For example, the message 5502 can indicate that Tina has set all request notifications to be sent to channel #admin-requests for review and approval.

### Example Clauses

A: A computer-implemented method for updating a user interface associated with a first user computing device of a user associated with a first organization, the user interface comprising a channel list pane, the computer-implemented method comprising: receiving, from a second user computing device associated with a second organization that is different than the first organization, a request for the user associated with the first organization to join a shared channel associated with the second organization and a third organization that is different from the first organization and the second organization; in response to receiving, from the first user computing device, an indication of acceptance of the request to join the shared channel, causing an indicator associated with the shared channel to be presented in the channel list pane of the user interface; and updating an organization list associated with the shared channel to include the first organization, the second organization, and the third organization.

B: The computer-implemented method of paragraph A, in response to receiving a user selection input associated with the indicator of the shared channel, causing a presentation of a shared channel organization set interface including a first organization indicator associated with the first organization, a second organization indicator associated with the second organization, and a third organization indicator associated with the second organization.

C: The computer-implemented method of paragraph B, wherein the shared channel organization set interface comprises a member count associated with each of the first organization indicator, the second organization indicator, and the third organization indicator.

D: The computer-implemented method of paragraph B, wherein the second organization indicator is associated with a host organization identifier and the first organization indicator and the third organization indicator are associated with non-host organization identifiers.

E: The computer-implemented method of any one of paragraphs A-D, further comprising: causing a shared channel indicator to be presented in the channel list pane in association with the shared channel, wherein the shared channel indicator provides a visual indication that the shared channel is associated with two or more organizations.

F: The computer-implemented method of paragraph E, further comprising: responsive to receiving an indication of selection of the shared channel indicator, causing data associated with the shared channel to be presented via the user interface, the data comprising at least a portion of the organization list.

G: The computer-implemented method of any one of paragraphs A-F, further comprising: receiving, from the first user computing device, a subsequent request to invite another user associated with first organization to join the shared channel; and in response to receiving a second indication of acceptance of invitation to join the shared channel, causing a presentation of the shared channel in a second user interface associated with a fourth user computing device associated with the other user.

H: The computer-implemented method of any one of paragraphs A-G, further comprising: receiving, from the second user computing device associated with the second organization, an indication that users associated with the first organization and the third organization are authorized to invite other users associated with other organizations to join the shared channel, wherein the second organization comprises a host organization of the shared channel; and sending, to the first user computing device, a message indicating that the user is authorized to invite the other users associated with the other organizations to join the shared channel.

I: The computer-implemented method of paragraph H, wherein the indication of acceptance is a first indication of acceptance, the computer-implemented method further comprising: receiving, from the first user computing device, a subsequent request to invite another user of a fourth organization to join the shared channel; and sending, to a fourth user computing device associated with the other user of the fourth organization, an invitation to join the shared channel; and in response to receiving a second indication of acceptance of the invitation, associating the fourth organization with the shared channel.

J: A system or device comprising: a processor; and a non-transitory computer-readable medium storing instructions that, when executed, cause a processor to perform a computer-implemented method of any one of paragraphs A-I.

K: A system or device comprising: a means for processing; and a means for storing coupled to the means for processing, the means for storing including instructions to configure one or more devices to perform a computer-implemented method of any one of paragraphs A-I.

L: An apparatus for updating a user interface associated with a first user computing device associated with a first organization of a user, the user interface comprising a channel list pane, and the apparatus comprising at least one processor and at least one non-transitory memory comprising program code, the at least one non-transitory memory and the program code being configured to, with the at least one processor, cause the apparatus to: receive, from a second user computing device associated with a second organization that is different than the first organization, a request for the user associated with the first organization to join a shared channel associated with the second organization and a third organization that is different from the first organization and the second organization; in response to receiving, from the first user computing device, an indication of acceptance of the request to join the shared channel, cause an indicator associated with the shared channel to be presented in the channel list pane of the user interface; and update an organization list associated with the shared channel to include the first organization, the second organization, and the third organization.

M: The apparatus of paragraph L, wherein the at least one non-transitory memory and the program code are further configured to, with the at least one processor, cause the apparatus to: in response to receiving a user selection input associated with the indicator of the shared channel, cause a presentation of a shared channel organization set interface including a first organization indicator associated with the first organization, a second organization indicator associated with the second organization, and a third organization indicator associated with the second organization.

N: The apparatus of paragraph M, wherein the shared channel organization set interface comprises a member count associated with each of the first organization indicator, the second organization indicator, and the third organization indicator.

O: The apparatus of paragraph M, wherein the second organization indicator is associated with a host organization identifier and the first organization indicator and the third organization indicator are associated with non-host organization identifiers.

P: The apparatus of any one of paragraphs L-O, wherein the at least one non-transitory memory and the program code are further configured to, with the at least one processor, cause the apparatus to: cause a shared channel indicator to be presented in association with the shared channel, wherein the shared channel indicator provides a visual indication that the shared channel is associated with two or more organizations.

Q: The apparatus of paragraph P, wherein the at least one non-transitory memory and the program code are further configured to, with the at least one processor, cause the apparatus to: responsive to receiving an indication of selection of the shared channel indicator, cause data associated with the shared channel to be presented via the user interface, the data comprising at least a portion of the organization list.

R: The apparatus of any one of paragraphs L-Q, wherein the at least one non-transitory memory and the program code are further configured to, with the at least one processor, cause the apparatus to: receive, from the first user computing device, a subsequent request to invite another user associated with the first organization to join the shared channel; and in response to receiving a second indication of acceptance of the subsequent request to join the shared channel, cause a presentation of the indicator of the shared channel in a second user interface associated with a fourth user computing device associated with the other user.

S: The apparatus of any one of paragraphs L-R, wherein the at least one non-transitory memory and the program code are further configured to, with the at least one processor, cause the apparatus to: receive, from the second user computing device associated with the second organization, an indication that users associated with the first organization and the third organization are authorized to invite other users associated with other organizations to join the shared channel, wherein the second organization comprises a host organization of the shared channel; and send, to the first user computing device, a message indicating that the user is authorized to invite the other users associated with the other organizations to join the shared channel.

T: The apparatus of any one of paragraphs L-S, wherein the indicator associated with the shared channel is a first indicator and the shared channel is a first shared channel, the channel list pane comprises: the first indicator associated with the first shared channel; a second indicator associated with a second shared channel; and a third indicator associated with an internal channel.

U: One or more non-transitory computer readable media for updating a user interface associated with a first user computing device of a user associated with a first organization, wherein the user interface comprises a channel list pane and the one or more non-transitory computer readable media store computer-executable instructions that, when executed by one or more processors of a computing device, cause the computing device to perform operations comprising: receiving, from a second user computing device associated with a second organization that is different than the first organization, a request for the user associated with the first organization to join a shared channel associated with the second organization and a third organization that is different from the first organization and the second organization; in response to receiving, from the first user computing device, an indication of acceptance of the request to join the shared channel, causing an indicator associated with the shared channel to be presented in the channel list pane of the user interface; and updating an organization list associated with the shared channel to include the first organization, the second organization, and the third organization.

V: The one or more non-transitory computer readable media of paragraph U, the operations further comprising: in response to receiving a user selection input associated with the indicator of the shared channel presented in the channel list pane, causing a presentation of a shared channel organization set interface including a first organization indicator associated with the first organization, a second organization indicator associated with the second organization, and a third organization indicator associated with the second organization.

### INCORPORATION BY REFERENCE

The entire contents of the following patent applications are incorporated herein by reference:
U.S. Patent Application Publication No. 2019/0026298, titled Method, Apparatus and Computer Program Product for Generating Externally Shared Communication Channels and filed Jul. 20, 2017;
U. S. Patent Application Publication No. 2019/0028287, titled Method, Apparatus and Computer Program Product for Generating Externally Shared Communication Channels and filed Nov. 17, 2017;
U. S. Patent Application Publication No. 2019/0098087, titled Method, Apparatus and Computer Program Product for Generating Externally Shared Communication Channels and filed Nov. 30, 2018;
U.S. patent application Ser. No. 16/681,452, titled Authorizations Associated with Externally Shared Communication Resources and filed Nov. 12, 2019; and
U.S. Patent Application No. 62/886,877, titled Dynamically Generated Context Pane Within A Group-Based Communication Interface and filed Aug. 14, 2019.

What is claimed is:

1. A computer-implemented method for updating a user interface associated with a first user computing device of a user associated with a first organization, the user interface comprising a channel list pane, the computer-implemented method comprising:
receiving, from a second user computing device associated with a second organization that is different than the first organization, a request for the user associated with the first organization to join a shared channel associated with the second organization and a third organization that is different from the first organization and the second organization;
in response to receiving, from the first user computing device, an indication of acceptance of the request to join the shared channel, causing an indicator associated with the shared channel to be presented in the channel list pane of the user interface; and
updating an organization list associated with the shared channel to include the first organization, the second organization, and the third organization.

2. The computer-implemented method of claim 1, in response to receiving a user selection input associated with the indicator of the shared channel, causing a presentation of a shared channel organization set interface including a first organization indicator associated with the first organization, a second organization indicator associated with the second organization, and a third organization indicator associated with the second organization.

3. The computer-implemented method of claim 2, wherein the shared channel organization set interface comprises a member count associated with each of the first organization indicator, the second organization indicator, and the third organization indicator.

4. The computer-implemented method of claim 2, wherein the second organization indicator is associated with a host organization identifier and the first organization indicator and the third organization indicator are associated with non-host organization identifiers.

5. The computer-implemented method of claim 1, further comprising:
causing a shared channel indicator to be presented in the channel list pane in association with the shared channel, wherein the shared channel indicator provides a visual indication that the shared channel is associated with two or more organizations.

6. The computer-implemented method of claim 5, further comprising:
responsive to receiving an indication of selection of the shared channel indicator, causing data associated with the shared channel to be presented via the user interface, the data comprising at least a portion of the organization list.

7. The computer-implemented method of claim 1, further comprising:
receiving, from the first user computing device, a subsequent request to invite another user associated with first organization to join the shared channel; and
in response to receiving a second indication of acceptance of invitation to join the shared channel, causing a presentation of the shared channel in a second user interface associated with a fourth user computing device associated with the other user.

8. The computer-implemented method of claim 1, further comprising:
receiving, from the second user computing device associated with the second organization, an indication that users associated with the first organization and the third organization are authorized to invite other users associated with other organizations to join the shared channel, wherein the second organization comprises a host organization of the shared channel; and
sending, to the first user computing device, a message indicating that the user is authorized to invite the other users associated with the other organizations to join the shared channel.

9. The computer-implemented method of claim 8, wherein the indication of acceptance is a first indication of acceptance, the computer-implemented method further comprising:
receiving, from the first user computing device, a subsequent request to invite another user of a fourth organization to join the shared channel; and
sending, to a fourth user computing device associated with the other user of the fourth organization, an invitation to join the shared channel; and
in response to receiving a second indication of acceptance of the invitation, associating the fourth organization with the shared channel.

10. An apparatus for updating a user interface associated with a first user computing device associated with a first organization of a user, the user interface comprising a channel list pane, and the apparatus comprising at least one processor and at least one non-transitory memory comprising program code, the at least one non-transitory memory and the program code being configured to, with the at least one processor, cause the apparatus to:
receive, from a second user computing device associated with a second organization that is different than the first organization, a request for the user associated with the first organization to join a shared channel associated with the second organization and a third organization that is different from the first organization and the second organization;
in response to receiving, from the first user computing device, an indication of acceptance of the request to join the shared channel, cause an indicator associated with the shared channel to be presented in the channel list pane of the user interface; and
update an organization list associated with the shared channel to include the first organization, the second organization, and the third organization.

11. The apparatus of claim 10, wherein the at least one non-transitory memory and the program code are further configured to, with the at least one processor, cause the apparatus to:
in response to receiving a user selection input associated with the indicator of the shared channel, cause a presentation of a shared channel organization set interface including a first organization indicator associated with the first organization, a second organization indicator associated with the second organization, and a third organization indicator associated with the second organization.

12. The apparatus of claim 11, wherein the shared channel organization set interface comprises a member count associated with each of the first organization indicator, the second organization indicator, and the third organization indicator.

13. The apparatus of claim 11, wherein the second organization indicator is associated with a host organization identifier and the first organization indicator and the third organization indicator are associated with non-host organization identifiers.

14. The apparatus of claim 10, wherein the at least one non-transitory memory and the program code are further configured to, with the at least one processor, cause the apparatus to:
cause a shared channel indicator to be presented in association with the shared channel, wherein the shared channel indicator provides a visual indication that the shared channel is associated with two or more organizations.

15. The apparatus of claim 14, wherein the at least one non-transitory memory and the program code are further configured to, with the at least one processor, cause the apparatus to:
responsive to receiving an indication of selection of the shared channel indicator, cause data associated with the shared channel to be presented via the user interface, the data comprising at least a portion of the organization list.

16. The apparatus of claim 10, wherein the at least one non-transitory memory and the program code are further configured to, with the at least one processor, cause the apparatus to:
receive, from the first user computing device, a subsequent request to invite another user associated with the first organization to join the shared channel; and
in response to receiving a second indication of acceptance of the subsequent request to join the shared channel, cause a presentation of the indicator of the shared channel in a second user interface associated with a fourth user computing device associated with the other user.

17. The apparatus of claim 10, wherein the at least one non-transitory memory and the program code are further configured to, with the at least one processor, cause the apparatus to:
receive, from the second user computing device associated with the second organization, an indication that users associated with the first organization and the third organization are authorized to invite other users associated with other organizations to join the shared channel, wherein the second organization comprises a host organization of the shared channel; and
send, to the first user computing device, a message indicating that the user is authorized to invite the other users associated with the other organizations to join the shared channel.

18. The apparatus of claim 10, wherein the indicator associated with the shared channel is a first indicator and the shared channel is a first shared channel, the channel list pane comprises:
the first indicator associated with the first shared channel;
a second indicator associated with a second shared channel; and
a third indicator associated with an internal channel.

19. One or more non-transitory computer readable media for updating a user interface associated with a first user computing device of a user associated with a first organization, wherein the user interface comprises a channel list pane and the one or more non-transitory computer readable media store computer-executable instructions that, when executed by one or more processors of a computing device, cause the computing device to perform operations comprising:
receiving, from a second user computing device associated with a second organization that is different than the first organization, a request for the user associated with the first organization to join a shared channel associated with the second organization and a third organization that is different from the first organization and the second organization;
in response to receiving, from the first user computing device, an indication of acceptance of the request to join the shared channel, causing an indicator associated with the shared channel to be presented in the channel list pane of the user interface; and
updating an organization list associated with the shared channel to include the first organization, the second organization, and the third organization.

20. The one or more non-transitory computer readable media of claim 19, the operations further comprising:
in response to receiving a user selection input associated with the indicator of the shared channel presented in the channel list pane, causing a presentation of a shared channel organization set interface including a first organization indicator associated with the first organization, a second organization indicator associated with the second organization, and a third organization indicator associated with the second organization.
